(19) United States
(12) Patent Application Publication
(10) Pub. No.: US 2021/0032387 A1
(43) Pub. Date: Feb. 4, 2021

(54) EMULSION POLYMERS CROSSLINKED WITH COMPOUNDS CONTAINING TWO OR MORE DICARBONYL-SUBSTITUTED 1 ALKENE UNITS

(71) Applicant: Sirrus, Inc., Loveland, OH (US)

(72) Inventors: Mengfei Huang, Sunderland, MA (US); Guozhen Yang, Middletown, CT (US); John Klier, Leverett, MA (US); Jessica Schiffman, Amherst, MA (US); Aniruddha Palsule, Cincinnati, OH (US); Mark Ronald Holzer, Lowell, AR (US)

(21) Appl. No.: 16/957,763

(22) PCT Filed: Jan. 11, 2019
(86) PCT No.: PCT/US2019/013146

§ 371 Date: Jun. 25, 2020

Related U.S. Application Data
(60) Provisional application No. 62/616,747, filed on Jan. 12, 2018.

(51) Int. Cl. C08F 220/18; C09D 133/08; C09D 133/02; C09D 133/12; C09D 133/14; C08G 63/52; C08K 5/00; C08F 2/30; C08F 2/26

(52) U.S. Cl. CPC C08F 220/18; C09D 133/08; C09D 133/02; C09D 133/12; C08F 2/26; C08G 63/52; C08K 5/0025; C08F 2/30; C09D 133/14

(57) ABSTRACT

Disclosed are novel compositions comprising emulsion polymers crosslinked by compounds containing the residue of at least two 1,1-diester-1-alkene compounds and methods for preparing these compositions. Further disclosed are coatings containing the compositions and methods for using the compositions as coatings.

### FIELD

Disclosed are novel compositions comprising emulsion polymers crosslinked by compounds containing the residue of at least two 1,1-diester-1-alkene compounds and methods for preparing these compositions. Further disclosed are coatings containing the compositions and methods for using the compositions as coatings.

### BACKGROUND

Water based coatings especially those from emulsion polymers are very broadly used in architectural coating applications and are rapidly gaining market share in industrial applications, having achieved very significant market penetration in North America and Europe. The water-based coating industry is in search of new crosslinking chemistries for several key reasons. The reduction of acceptable volatile organic compound (VOC) levels in emulsion polymer coatings requires the emulsion polymers to have a low glass transition temperature to facilitate adequate film formation upon coating. A low glass transition temperature inherently results in coatings that have low or inadequate mechanical properties. Crosslinking chemistries, which react with the emulsion polymer and bridge adjacent polymer chains can restore or enhance the mechanical properties, enabling low VOC coatings that are high performance systems. However, known crosslinking systems have several inherent deficiencies. Many only function (or cure) at elevated temperatures, precluding their use in outdoor or room temperature applications. Others, such as polyisocyanates, are viewed as inherently hazardous, reducing their attractiveness. Many other applications of emulsion polymers such as binders for nonwovens, adhesives, rubber and plastic tougheners and concrete additives will also benefit from crosslinking.

Therefore, there is a very strong unmet need in the industry to provide crosslinking chemistries for emulsion polymers that provide room temperature or low temperature cure, do not have the hazardous properties of polyisocyanates, maintain adequate pot life, and enhance coating properties.

What is needed are water-based coating compositions useful in preparing coating compositions which can be cross-linked elegantly without the need for problematic catalysts and use relatively mild conditions. What is also needed are coatings prepared from such compositions that exhibit enhanced properties, such as flexibility, adhesion to substrates, pencil hardness, solvent resistance, abrasion resistance, ultraviolet radiation resistance, high temperature acid and base resistance, fuel resistance. Processes that prepare the coatings are needed.

### SUMMARY

Disclosed are compositions comprising polymers having polymer chains prepared from monomers having unsaturated groups and functional groups which are nucleophilic or mixtures of monomers having unsaturated groups and monomers having unsaturated groups and functional groups which are nucleophilic, wherein the polymer chains are crosslinked by compounds containing two or more 1,1-dicarbonyl 1-alkene groups. The polymer chains alternatively can be any polymers dispersed in water which contain functional groups which are nucleophilic, such as polyolefin dispersions, alkyd dispersions, polyurethane dispersions and epoxy-based dispersions. Functional polymers with the desired groups can also be made by cationic polymerization, condensation polymerization, addition polymerization of diisocyanates with carboxylated diols to make carboxylated polyurethanes, mechanical dispersions of any of the above (such as dispersions of EAA), dispersions of post-functionalized polymers such as maleated polyolefins or acrylic acid grafted polymers. The polymer chains are crosslinked by the alkene groups of the compounds containing two or more 1,1-dicarbonyl 1-alkene groups reacting with the nucleophilic groups of the polymer chains. The nucleophilic groups may be any nucleophilic groups which react with the alkene groups of 1,1-dicarbonyl 1-alkenes. Exemplary nucleophilic groups include hydroxyl, carboxylic acids, amines, benzoic acids, sulfonates, and sulfates and the like. The acids become nucleophilic when at least partially neutralized. Consequently, the acids are nucleophilic when fully neutralized or are deprotonated. The acceptable level of neutralization is the level of neutralization at which an acceptable level of cross-linking can be achieved. An acceptable level of cross-linking is that level that provides the desired properties for the cured coating as described herein or the amount of nucleophilic groups as described herein. The polymers may contain about 0.1 percent by weight or greater of monomers containing nucleophilic functional groups or about 0.1 percent by weight or greater of monomers containing nucleophilic functional groups. The polymers may contain from about 0.1 percent by weight to about 20 percent by weight of the monomers containing nucleophilic functional groups. The composition may contain about 0.1 percent of greater or about 2 percent by weight of the composition or greater of compounds containing two or more 1,1-dicarbonyl alkene groups. The composition may contain from about 2 percent to 15 percent by weight of the composition or greater of compounds containing two or more 1,1-dicarbonyl alkene groups. Below 0.1 percent the improvement in properties of coatings prepared from the composition is not significant. Up to 15 percent by weight the properties of coatings prepared from the composition show significant improvement.

The monomers having unsaturated groups comprise compounds that contain unsaturation in their backbone wherein the unsaturation is capable of polymerization via free radical or anionic polymerization. The monomers having unsaturated groups may comprise one or more of acrylates, methacrylates, acrylamides, methacrylamides, vinyl acetate, mono-vinylidene aromatic compounds, olefins, isocyanates, 1,1-dicarbonyl-1alkenes and conjugated dienes. The monomers having unsaturated groups may comprise one or more of acrylates, methacrylates, acrylamides, and methacrylamides. The monomers having unsaturated groups may comprise one or more acrylates and/or methacrylates. The monomers having unsaturated groups and functional groups which are nucleophilic may comprise one or more of methacrylic acid, acrylic acid, ethylene acrylic acid, maleic anhydride, 2-Acrylamido-2-methylpropanesulfonic acid, and acetoacetoxyethyl methacrylate. The acids may be partially or completely neutralized or deprotonated.

The compounds containing two or more 1,1-dicarbonyl alkene groups comprise one or more compounds prepared from one or more 1,1-dicarbonyl-1-alkenes and one or more polyols or from two or more 1,1-dicarbonyl-1-alkenes, one or more polyols and one or more diesters. The compounds containing two or more 1,1-dicarbonyl alkene groups may comprise one or more polyester macromers containing one or more chains of the residue of one or more diols and one or more diesters wherein the residue of the one or more diols and the one or more diesters alternate along the chain and a portion of the diesters are 1,1-diester-1-alkenes and at least one terminal end comprises the residue of one of the 1,1-diester-1 alkenes and wherein one or more terminal ends may comprise the residue of one or more diols. The one or more chains of the residue of one or more diols and one or more diesters may contain from 2 to 20 repeating units comprising the residue of at least one diester and one diol. The compounds containing two or more 1,1-dicarbonyl alkene groups may comprise one or more polyester macromers prepared from butane diol and diethyl methylene malonate. The compounds containing two or more 1,1-dicarbonyl alkene groups comprise one or more compounds prepared from one or more 1,1-dicarbonyl-1-alkenes and one or more polyols. The compounds containing two or more 1,1-dicarbonyl alkene groups comprise one or more compounds prepared from two 1,1-dicarbonyl-1-alkenes and one diol to form a compound wherein the diol is end-capped with the two 1,1-dicarbonyl-1-alkenes.

Disclosed is a composition comprising polymers having polymer chains prepared from monomers having unsaturated groups and monomers having unsaturated groups and functional groups which are nucleophilic, wherein the polymer chains are crosslinked by compounds containing two or more 1,1-dicarbonyl alkene groups dispersed in an aqueous dispersion containing one or more surfactants. Any surfactants that form a stable emulsion in water of the recited polymers may be used. The surfactant may be one or more of anionic surfactants or non-ionic surfactants; one or more of non-ionic surfactants. The non-ionic surfactants may increase the rate of polymerization.

Disclosed is a method comprising polymerizing in an aqueous emulsion of monomers having unsaturated groups and functional groups which are nucleophilic or mixtures of monomers having unsaturated groups and monomers having unsaturated groups and functional groups which are nucleophilic to form polymers with one or more polymer chains wherein the nucleophilic groups are pendant from the polymer chains formed and the polymers formed are contacted with compounds containing two or more 1,1-dicarbonyl alkene groups such that the compounds containing two or more 1,1-dicarbonyl alkene groups react with the nucleophilic groups to crosslink the polymer chains. The surfactants are present in a sufficient amount to form a stable emulsion. The concentration of the surfactant may be about 0.001 weight percent or more, about 0.01 weight percent or more, about 0.1 weight percent or more, or about 0.5 weight percent or more, based on the total weight of the emulsion. The concentration of the surfactant may be about 15 weight percent or less, about 10 weight percent or less, and more preferably about 6 weight percent or less, or about 3 weight percent or less, based on the total weight of the emulsion. The temperature at which the one or more polymer chains wherein the nucleophilic groups are pendant from the polymer chains are contacted with the compounds containing two or more 1,1-dicarbonyl alkene groups may be about 0° C. to about 80° C. or 100° C. Slight overpressure may be used as well. The method may comprise contacting water and a surfactant to form a micellar dispersion and adding to the micellar dispersion one or more polymerization initiators and monomers having unsaturated groups and functional groups which are nucleophilic or mixtures of monomers having unsaturated groups and monomers having unsaturated groups and functional groups which are nucleophilic to form polymers with polymer chains. The pH of the emulsion may be about 4 or greater. The pH of the emulsion may be about 7 or greater. The pH of the emulsion may be about 4 to about 10. The pH of the emulsion may be about 7 to about 10. The surfactant used in the method includes those disclosed herein previously.

Disclosed is a method of forming a coating on a substrate comprising applying to the surface of the substrate a composition as disclosed hereinbefore in the form of an aqueous emulsion and allowing the water to volatilize away and the crosslinked polymer to from a coherent coating. The composition may be contacted with a substrate at ambient or elevated temperatures. The composition may be contacted with a substrate at temperatures of about of about 20° C. to about 150° C. The composition is contacted with a substrate at temperatures of about of about 20° C. to about 50° C. Disclosed is a method comprising contacting a stabilized emulsion of polymers having polymer chains prepared from monomers having unsaturated groups and functional groups which are nucleophilic and mixtures of monomers having unsaturated groups and monomers having unsaturated groups and functional groups which are nucleophilic with compounds containing two or more 1,1-dicarbonyl alkene groups under conditions such that the polymer chains are crosslinked by compounds containing two or more 1,1-dicarbonyl alkene groups.

Disclosed is an article having a coating containing polymers having polymer chains prepared from monomers having unsaturated groups and functional groups which are nucleophilic and mixtures of monomers having unsaturated groups and monomers having unsaturated groups and functional groups which are nucleophilic, wherein the polymer chains are crosslinked by compounds containing two or more 1,1-dicarbonyl 1-alkene groups. The article may have a base coat upon which the coating formulation is deposited. The base coat may contain pigments. The base coat may have a basic pH at the surface. The pigments may be basic. The base coat may have amine groups or hydroxyl groups on the surface that may help with the cure process and adhesion of the coating to the substrate. The coating may be clear. The coating may contain pigments or other known ingredients used in coatings.

### DESCRIPTION OF FIGURES

FIG. 1 illustrates the reaction equation for the formation of Polyester Macromers.

FIG. 2 illustrates the reaction equation for the formation of Polyester Macromers.

### DETAILED DESCRIPTION

The explanations and illustrations presented herein are intended to acquaint others skilled in the art with the invention, its principles, and its practical application. The specific embodiments of the present invention as set forth are not intended to be exhaustive or limiting of the invention. The scope of the disclosure should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Disclosed are compositions comprising polymers having polymer chains prepared from monomers having unsaturated groups and functional groups which are nucleophilic groups or mixtures of monomers having unsaturated groups and monomers having unsaturated groups and functional groups which are nucleophilic, wherein the polymer chains are crosslinked by compounds containing two or more 1,1-dicarbonyl 1-alkene groups. Disclosed are systems capable of preparing crosslinked polymers comprising polymers having polymer chains prepared from monomers having unsaturated groups and functional groups which are nucleophilic groups or mixtures of monomers having unsaturated groups and monomers having unsaturated groups and functional groups which are nucleophilic in one part and in a second part compounds containing two or more 1,1-dicarbonyl 1-alkene groups. The two parts can be contacted to form crosslinked polymers wherein the polymer chains are crosslinked by compounds containing two or more 1,1-dicarbonyl 1-alkene groups. Disclosed are methods for preparing the crosslinked polymers. The compounds containing two or more 1,1-dicarbonyl 1-alkene groups may be any compounds which contain two of more 1,1-dicarbonyl 1-alkene groups. Exemplary compounds which contain two or more 1,1-dicarbonyl 1-alkene groups include difunctional compounds containing 1,1-dicarbonyl 1-alkene groups, multifunctional compounds containing 1,1-dicarbonyl 1-alkene groups and compounds described as polyester macromers. The monomers having unsaturated groups comprise compounds that contain unsaturation in their backbone wherein the unsaturation is capable of polymerization via free radical or anionic polymerization.

Unless defined otherwise, all technical and scientific terms used herein have the meaning commonly understood by a person skilled in the art to which this disclosure belongs. The following references provide one of skill with a general definition of many of the terms used in this disclosure: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). The following terms have the meanings ascribed to them below, unless specified otherwise.

Compounds containing 1,1-dicarbonyl 1-alkene groups are compounds that contains two carbonyl groups and a double bond bonded to a single carbon atom referred to as the one carbon atom. The carbonyl groups may be bonded to hydrocarbyl groups through a direct bond, oxygen or amino groups. As used herein, diester refers to any compound having two ester groups which can be subjected to transesterification. A 1,1-diester-1-alkene is a compound that contains two ester groups and a double bond bonded to a single carbon atom referred to as the one carbon atom. Dihydrocarbyl dicarboxylates are diesters having a hydrocarbylene group between the ester groups wherein a double bond is not bonded to a carbon atom which is bonded to two carbonyl groups of the diester.

The term “monofunctional” refers to the 1,1-dicarbonyl 1-alkenes, such as 1,1-diester-1-alkenes, having only one core unit. The core unit comprises two carbonyl groups and a double bond bonded to a single carbon atom. The term “difunctional” refers to the 1,1-dicarbonyl 1-alkenes such as 1,1-diester-1-alkenes having two core units (each including the reactive alkene functionality) bound through a hydrocarbylene linkage between one oxygen atom on each of two core formulas. The term “multifunctional” refers to the 1,1-dicarbonyl 1-alkenes such as 1,1-diester-1-alkenes having two or more core units (each core unit including the reactive alkene functionality) bound together through a hydrocarbylene linkage between one oxygen atom on each of two or more core formulas.

Acid catalyst, as used herein, is an acidic species that catalyzes the transesterification reaction while minimizing or not contributing to side reactions. One or more as used herein means that at least one, or more than one, of the recited components may be used as disclosed. Nominal as used with respect to functionality refers to the theoretical functionality; generally, this can be calculated from the stoichiometry of the ingredients used. Heteroatom refer to atoms that are not carbon or hydrogen such as nitrogen, oxygen, sulfur, and phosphorus; heteroatoms may include nitrogen and oxygen. Hydrocarbyl, as used herein, refers to a group containing one or more carbon atom backbones and hydrogen atoms, which may optionally contain one or more heteroatoms. Where the hydrocarbyl group contains heteroatoms, the heteroatoms may form one or more functional groups well-known to one skilled in the art. Hydrocarbyl groups may contain cycloaliphatic, aliphatic, aromatic, or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl, and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. As used herein percent by weight or parts by weight refer to, or are based on, the weight or the compounds or compositions described unless otherwise specified. Unless otherwise stated parts by weight are based 100 parts of the relevant composition.

The terms “volatile” refers to compounds which are capable of evaporating readily at normal temperatures and pressures. “Non-volatile” refers to compounds which are not capable of evaporating readily at normal temperatures and pressures. The term “stabilized” (in the context of “stabilized” 1,1-dicarbonyl 1-alkenes, such as 1,1-diester-1-alkenes, or compositions comprising the same,) refers to the tendency of the compounds (or their compositions) to substantially not polymerize with time, to substantially not harden, form a gel, thicken, or otherwise increase in viscosity with time, and/or to substantially show minimal loss in cure speed (cure speed is maintained) with time. Residue with respect to an ingredient used to prepare the compositions disclosed herein means that portion of the ingredient, such as a polyol, such as a diol, a diester, such as a 1,1-dicarbonyl-1-alkene, a dihydrocarbyl dicarboxylate and/or monomers as disclosed herein, that remains in the compound after inclusion as a result of the methods disclosed herein. Substantially all as used herein that greater than 95 percent of the referenced parameter, composition or compound meet the defined criteria, greater than 99 percent of the referenced parameter, composition or compound meet the defined criteria, or greater than 99.5 percent of the referenced parameter, composition or compound meet the defined criteria. Nucleophilic group as used herein is a group which donates an electron pair to form a covalent bond. Exemplary nucleophilic groups include carboxylic acid, carboxylate, alcohol, phenol, amine, aniline, imidazole, tetrazole, thiol, boronic acid, glycol, hydrazine and hydroxyl amine groups. Nucleophilic groups may be carboxylic acid groups. The acids become nucleophilic when at least partially neutralized or are deprotonated. Consequently, the acids are nucleophilic when fully neutralized or are deprotonated. The acceptable level of neutralization is the level of neutralization at which an acceptable level of cross-linking can be achieved. An acceptable level of cross-linking is that level that provides the desired properties for the cured coating as described herein or the number of nucleophilic groups as described herein. The one or more unsaturated compounds containing nucleophilic groups may be (meth) acrylic acids, (meth)acrylates, hydroxyalkyl methacrylates, and the like. (Meth) acrylate as used herein refers to compounds having a vinyl group bonded to the carbonyl moiety of an alkyl ester wherein the carbon of the vinyl group bonded to the carbonyl group further has a hydrogen or a methyl group bonded thereto. The term (meth) as used in this context refers to compounds having either of a hydrogen or methyl group on the carbon of the vinyl group bonded to the carbonyl group.

Compounds which contain two or more 1,1-dicarbonyl 1-alkene groups may be difunctional compounds containing 1,1-dicarbonyl 1-alkene groups or multifunctional compounds containing 1,1-dicarbonyl 1-alkene groups. Such compounds may comprise two or more 1,1-dicarbonyl 1-alkene groups connected by the residue of a diol or polyol capable of transesterifying 1,1-dicarbonyl 1-alkenes.

Compounds which contain two or more 1,1-dicarbonyl 1-alkene groups may be polyester macromers which contain one or more chains containing the residue of one or more diols and one or more diesters wherein a portion of the diesters comprise 1,1-diester-1-alkenes. The residue of the diols and the diesters can alternate along the chains or can be disposed randomly along the chains. The diesters may further comprise any diester compound that will undergo transesterification with a polyol or diol. Among diester compounds are dihydrocarbyl dicarboxylates. The polyester macromers may have three or more chains as described. The polyester macromers having three or more chains contain the residue of a polyol originally having three or greater hydroxyl groups. The three or more chains propagate from each of the three or more hydroxyl groups. The polyols having three or more chains function as initiators from which each of the chains of the polyester macromers propagate. If the polyol is a diol a single chain is produced because the macromer formed is linear. Where a polyol having three or more hydroxyls is used to prepare the macromer, it may have two or more chains as not all of the hydroxyls may propagate chains. The macromers may contain one or more chains, may contain two or more chains, or may contain three or more chains. The macromers may contain eight or less chains, six or less chains, four or less chains or three or less chains. The chains may comprise the residue of one or more polyols, one or more diols and one or more diesters, including one or more 1,1-diester-1-alkenes and optionally one or more dihydrocarbyl dicarboxylates. The chains may comprise the residue of one or more diols and one or more diesters, including one or more 1,1-diester-1-alkenes and optionally one or more dihydrocarbyl dicarboxylates. The polyester macromers contain the residue of at least one 1,1-diester-1-alkenes at the terminal end of one of the chains. The polyester macromers may further comprise one or more diols or dihydrocarbyl dicarboxylates at the terminal end of one or more of the chains. Substantially all of the terminal ends of chains may be 1,1-diester-substituted alkenes.

The polyester macromers may comprise sufficient amount of the residue of one or more polyols, in this context the polyols have 3 or greater hydroxyl groups, to initiate the desired number of chains. The residue of the polyols in the polyester macromers may be about 20 mole percent or greater of the macromer; 30 mole percent or greater or about 40 mole percent or greater. The residue of the polyols in the polyester macromers may be about 50 mole percent or less; or about 40 mole percent or less. The polyester macromers may comprise sufficient amount of the residue of one or more diols, in this context the polyols have 2 hydroxyl groups, to prepare polyester macromers having the desired chain length and number average molecular weight. The residue of the dials in the polyester macromers may be about 20 mole percent or greater of the macromer; 40 mole percent or greater or about 50 mole percent or greater. The residue of the diols in the polyester macromers may be about 50 mole percent or less; 40 mole percent or less or about 30 mole percent or less. The polyester macromers may comprise sufficient amount of the residue of the 1,1-diester-substituted-1-alkenes to provide the desired crosslink density to compositions containing the polyester macromers. The residue of the 1,1-diester-substituted-1-alkenes in the polyester macromers may be about 20 mole percent or greater of the macromer; 30 mole percent or greater or about 40 mole percent or greater. The residue of the 1,1-diester-substituted-1-alkenes in the polyester macromers may be about 60 mole percent or less of the macromer; about 50 mole percent or less of the macromer; about 40 mole percent or less or about 30 mole percent or less. The polyester macromers may comprise sufficient amount of the residue of the dihydrocarbyl dicarboxylates to provide the desired space between crosslinks to compositions containing the polyester macromers to provide the desired flexibility and/or elasticity to the structures containing the polyester macromers. The residue of the dihydrocarbyl dicarboxylates in the polyester macromers may be about 10 mole percent or greater of the polyester macromer; 20 mole percent or greater or about 30 mole percent or greater. The residue of the dihydrocarbyl dicarboxylates in the polyester macromers may be about 30 mole percent or less of the polyester macromer; 20 mole percent or less or about 10 mole percent or less.

The polyester macromers may correspond to Formula 1

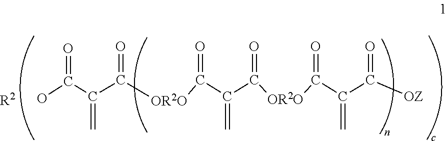

wherein Z is separately in each occurrence —R²OH or —R¹; R¹ is separately in each occurrence a hydrocarbyl group which may contain one or more heteroatoms; R² is separately in each occurrence a hydrocarbylene group having two or more bonds to oxygen atoms; c is an integer of 1 or more; and n is an integer of about 1 to 3. With respect to R² the bonds to oxygen atoms may include bonds to the oxygen of a polyol, a diol, or a diester or the residue thereof depending on the context of use of R².

The polyester macromers may contain one chain of the residue of one or more diols and one or more diesters. These polyester macromers may correspond to Formula 2,

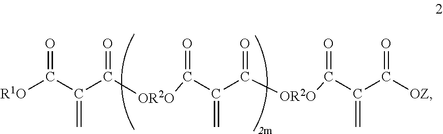

wherein Z, R¹ and R² are as previously defined; and m is an integer of about 1 to 3.

The polyester macromers containing the residue of one or more 1,1-diester-1-alkenes and the residue of one or more dihydrocarbyl dicarboxylates may correspond to one of Formulas 3 to 6:

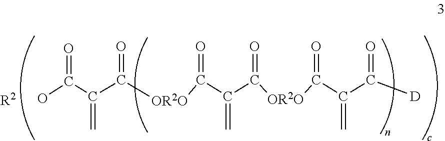

wherein D corresponds to the formula

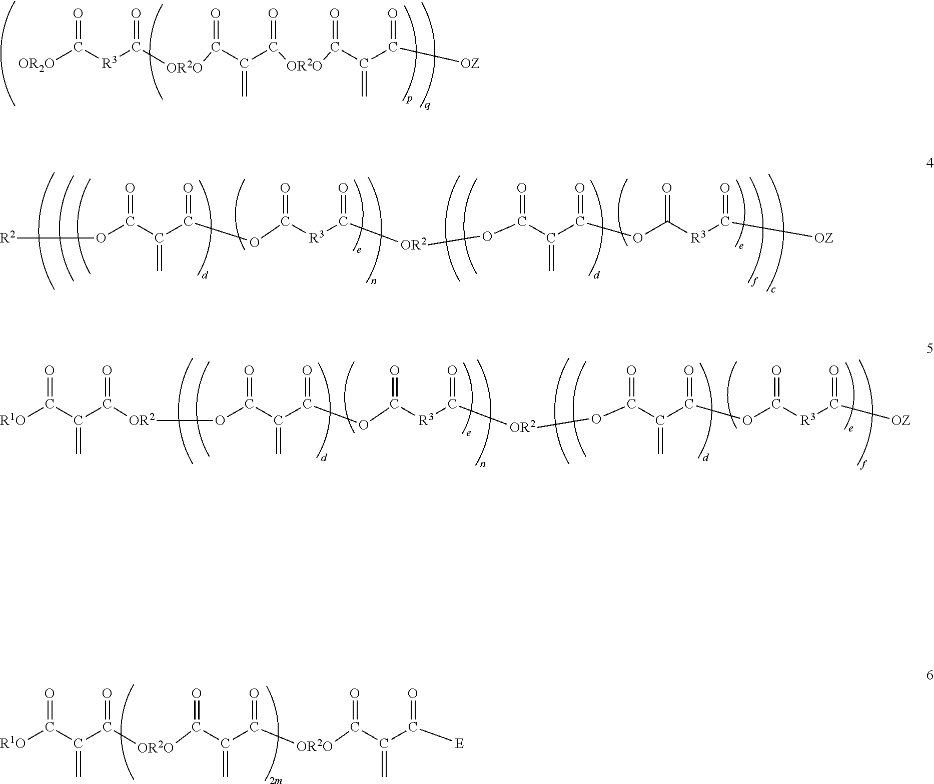

wherein E corresponds to the formula,

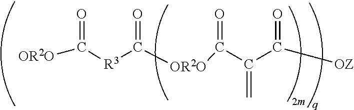

wherein Z, R¹, R² and m are as previously defined; R³ is separately in each occurrence a hydrocarbylene group having two bonds to the carbonyl groups of one or more of the diesters or to the residue of such diesters depending on the context, wherein the hydrocarbylene group may contain one or more heteroatoms; c is an integer of 1, or 2 or more; d is an integer of 0 or 1; e is an integer of 0 or 1; f is the integer 1; n is an integer of about 1 to 3; p is an integer of 2 or more; and q is an integer of 1 or more; wherein each pair of d and e must equal 1. p may be an integer of 3 or greater. p may be an integer of 8 or less, 6 or less or 3 less. q may be an integer of 4 or less or 3 or less.

The polyester macromers may contain in their backbone repeating units comprising the residue of at least one diester and one diol. A significant portion of the diesters are 1,1-diestersubstituted-1-alkenes. A portion of the diesters may be 1,1-dihydrocarbyl dicarboxylates. The backbone of polyester macromers contain a sufficient number of repeating units comprising the residue of at least one diester and one diol to facilitate the use of the polyester macromers as disclosed herein, such as in coatings. The number of repeating units comprising the residue of at least one diester and one diol in polyester macromers may be 2 or greater, 4 or greater or 6 or greater. The number of repeating units comprising the residue of at least one diester and one diol in polyester macromers may be 20 or less, 14 or less, 10 or less, 8 or less, 6 or less, or 4 or less. The diesters in some polyester macromers can be all 1,1-diester-1-alkenes. The diesters in some polyester macromers can be 1,1-diester-1-alkenes and dihydrocarbyl dicarboxylates. The molar ratio of 1,1-diester-1-alkenes and dihydrocarbyl dicarboxylates in some polyester macromers is selected to provide the desired degree of crosslinking in structures prepared from the polyester macromers. The molar ratio of 1,1-diester-1-alkenes and dihydrocarbyl dicarboxylates in some polyester macromers may be 1:1 or greater, 6:1 or greater or 10:1 or greater. The molar ratio of 1,1-diestersubstituted-1-alkenes and dihydrocarbyl dicarboxylates in some polyester macromers may be 15:1 or less, 10:1 or less, 6:1 or less or 4:1 or less. The polyester macromers may exhibit a number average molecular weight of about 700 or greater, about 900 or greater, about 1000 or greater or about 1200 or greater. The polyester macromers may exhibit a number average molecular weight of about 3000 or less, about 2000 or less or about 1600 or less. Number average molecular weight as used herein is determined dividing total weight of all the polymer molecules in a sample, by the total number of polymer molecules in a sample. The polydispersity of the polyester macromers may be about 1.05 or greater or about 1.5 or greater. The polydispersity of the polyester macromers may be about 4.5 or less or about 2.5 or less, about 2.5 or less or about 1.5 or less. For calculating the polydispersity the weight average molecular weight is determined using gel permeation chromatography using polymethylmethacrylate standards. Polydispersity is calculated by dividing the measured weight average molecular weight (Mᵥ) by the number average molecular weight (Mₙ), that is Mᵥ/Mₙ.

The polyester macromers disclosed may be prepared from 1,1-diester-1-alkenes, diols, polyols and/or dihydrocarbyl dicarboxylates. The choice of specific ingredients, ratios of ingredients and sequence of process steps impact the final structure and content of the polyester macromers. The presence of polyols having greater than two hydroxyl groups function to initiate the chains and their use results in the formation of polyester macromers having more than two chains, that is the macromers exhibit branching and are not linear. The 1,1-diester-1-alkenes help form the chains and introduce pendant alkene groups capable of crosslinking via anionic and/or free radical polymerization and/or Michael addition. The diols may initiate a single chain and chain extend the polyester macromers. The dihydrocarbyl dicarboxylates help form the chains and function to space the pendant alkene groups from one another, thereby increasing the distance between crosslinks and the average molecular weight per crosslink. The polyester macromers disclosed may be prepared as disclosed in U.S. Pat. No. 9,617,377 incorporated herein by reference in its entirety.

The 1,1-dicarbonyl-1-alkenes, such as 1,1-diester-1-alkenes, comprise a central carbon atom referred to as the 1 carbon atom. Bonded to the 1 carbon atom are carbonyl groups and another carbon atom via a double bond. The double bond, due to it being bonded to two carbonyl groups, is highly reactive. The doubly bonded carbons may be part of an alkenyl group which is highly reactive. The alkenyl group may be a C₂₋₄ alkenyl group, or a methylene group (C═C). The di-carbonyl compounds contain hydrocarbyl groups bonded to directly to the carbonyl groups or to an oxygen or nitrogen bonded to the carbonyl groups wherein the hydrocarbyl groups may contain one or more heteroatoms, including heteroatom containing functional groups. The hydrocarbyl groups can be any hydrocarbyl groups that can undergo transesterification under the conditions disclosed herein. The hydrocarbyl groups on the ester may be separately in each occurrence alkyl, alkenyl, cycloalkyl, heterocyclyl, alkyl heterocyclyl, aryl, aralkyl, alkaryl, heteroaryl, alkheteroaryl, or polyoxyalkylene, or both of the hydrocarbyl groups may form a 5-7 membered cyclic or heterocyclic ring. The hydrocarbyl groups on the ester may be separately in each occurrence C₁-C₁₅ alkyl, C₂-C₁₅ alkenyl, C₃-C₉ cycloalkyl, C₂₋₂₀ heterocyclyl, C₃₋₂₀ alkheterocyclyl, C₆₋₁₈ aryl, C₀₇₋₂₅ alkaryl, C₇₋₂₅ aralkyl, C₅₋₁₈ heteroaryl or C₆₋₂₅ alkyl heteroaryl, or polyoxyalkylene, or both hydrocarbyl groups form a 5-7 membered cyclic or heterocyclic ring. The recited groups may be substituted with one or more substituents, which do not interfere with the transesterification reaction. Exemplary substituents include halo, alkylthio, alkoxy, hydroxyl, nitro, azido, cyano, acyloxy, carboxy, or ester. The hydrocarbyl groups on the ester may be separately in each occurrence C₁-C₁₅ alkyl, C₃-C₆ cycloalkyl, C₄₋₁₈ heterocyclyl, C₄₋₁₈ alkheterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene. The hydrocarbyl groups on the ester may be separately in each occurrence a C₁₋₄ alkyl. The hydrocarbyl groups on the ester may be separately in each occurrence methyl or ethyl. The hydrocarbyl groups on the ester may be the same for each ester group on the 1,1-di-1-alkene compounds. Exemplary compounds are dimethyl, diethyl, ethylmethyl, dipropyl, dibutyl, diphenyl, and ethyl-ethylgluconate malonates. The compounds may be dimethyl and diethyl methylene malonate. The 1,1-dicarbonyl- or 1,1-diester-1-alkenes can be prepared as disclosed in Malofsky et al., U.S. Pat. Nos. 8,609,885 8,884,051, 9,221739 and 9,527,795; and Malofsky et al. U.S. Pat. No. 9,108,914.

The 1,1-diester-1-alkene compounds may correspond to formula 7:

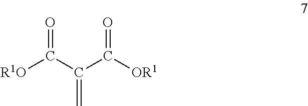

R¹ is separately in each occurrence a group that can undergo replacement or transesterification under the conditions of the methods disclosed herein. R¹ may be separately in each occurrence alkyl, alkenyl, cycloalkyl, heterocyclyl, alkyl heterocyclyl, aryl, aralkyl, alkaryl, heteroaryl, or alkyl heteroaryl, or polyoxyalkylene, or both R¹s form a 5-7 membered cyclic or heterocyclic ring. R¹ may be separately in each occurrence C₁-C₁₅ alkyl, C₂-C₁₅ alkenyl, C₃-C₉ cycloalkyl, C₂₋₂₀ heterocyclyl, C₃₋₂₀ alkyl heterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene, or both 1:11 groups form a 5-7 membered cyclic or heterocyclic ring. The recited groups may be substituted with one or more substituents, which do not interfere with the transesterification reaction. Exemplary substituents include halo alkylthio, alkoxy, hydroxyl, nitro, azido, cyano, acyloxy, carboxy, or ester. R¹ may be separately in each occurrence C₁-C₁₅ alkyl, C₃-C₆ cycloalkyl, C₄₋₁₈ heterocyclyl, C₄₋₁₈ alkheterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene. R¹ may be separately in each occurrence a C₁₋₆ alkyl. R¹ may be separately in each occurrence methyl, ethyl hexyl, or cyclohexyl. R¹ may be the same or different for each ester group on the 1,1-disubstituted alkene compounds.

The 1,1-disubstituted alkene compounds may be methylene malonates which may correspond to formula 8:

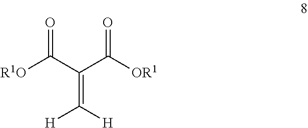

wherein R¹ is as described herein before.

The 1,1-dicarbonyl-alkenes may be prepared using a method which results in a sufficiently high purity so that they can be included into polyester macromers that can be polymerized and/or crosslinked. The purity of the 1,1-dicarbonyl-1-alkenes may be sufficiently high so that 70 mole percent or more, 80 mole percent or more, 90 mole percent or more, 95 mole percent or more, or 99 mole percent or more of the polyester macromers containing 1,1-dicarbonyl1-alkenes may be converted to polymer during a polymerization or curing process. The purity of the 1,1-dicarbonyl-1-alkenes may be about 85 mole percent or more, about 90 mole percent or more, about 93 mole percent or more, about 95 mole percent or more, about 97 mole percent or more, or about 99 mole percent or more, based on the total moles of the 1,1-dicarbonyl-1-alkenes. If the 1,1-dicarbonyl-1-alkenes includes the analogous 1,1-dicarbonyl alkane it may be about 10 mole percent or less, or about 1 mole percent or less. The concentration of any impurities containing a dioxane group may be about 2 mole percent or less, about 1 mole percent or less, about 0.2 mole percent or less, or about 0.05 mole percent or less, based on the total moles of the 1,1-dicarbonyl-1-alkenes. The total concentration of any impurity having the alkene group replaced by an analogous hydroxyalkyl group (e.g., by a Michael addition of the alkene with water) may be about 3 mole percent or less, about 1 mole percent or less, about 0.1 mole percent or less, or about 0.01 mole percent or less, based on the total moles in the 1,1-dicarbonyl-1-alkenes. The 1,1-diester-1-alkenes may be prepared by a process including one or more or two or more steps of distilling a reaction product or an intermediate reaction product, such as a reaction product or intermediate reaction product of a source of formaldehyde and a malonic acid ester).

Polyols useful in preparing Bifunctional compounds containing 1,1-dicarbonyl 1-alkene groups, multifunctional compounds containing 1,1-dicarbonyl 1-alkene groups and polyester macromers disclosed herein are compounds having a hydrocarbylene backbone with two or more hydroxyl groups bonded to the hydrocarbylene backbone and which may be capable of transesterifying ester compounds under the transesterification conditions disclosed herein. Polyols useful herein fall in two groups. The first group are diols which have two hydroxyl groups bonded to a hydrocarbylene backbone and which function to both initiate and extend the chains of the polyester macromere. Polyols with greater than two hydroxyl groups bonded to the hydrocarbylene backbone function to initiate more than two chains. Dials may also function to extend the more than two chains. The polyols may have from 2 to 19 hydroxyl groups, from 2 to 4 hydroxyl groups or from 2 to 3 hydroxyl groups. The backbone for the polyols, including dials, may be alkylene, alkenylene, cycloalkylene, heterocyclylene, alkyl heterocyclylene, arylene, aralkylene, alkyl arylene, heteroarylene, alkyl heteroarylene, or poly-oxyalkylene. The backbone may be C₁-C₁₅ alkylene, C₂-C₁₅ alkenylene, C₃-C₉ cycloalkyene, C₂₋₂₀ heterocyclylene, C₃₋₂₀ alkheterocyclylene, C₆₋₁₈ arylene, C₇₋₂₅ alkarylene, C₇₋₂₅ aralkylene, 18 heteroarylene, C₆₋₂₅ alkyl heteroarylene or polyoxyalkylene. The alkylene sections may be straight or branched. The recited groups may be substituted with one or more substituents that do not interfere with the transesterification reaction. Exemplary substituents include halo alkylthio, alkoxy, hydroxyl, nitro, azido, cyano, acyloxy, carboxy, or ester. The backbone may be C₂₋₁₀ alkylene groups. The backbone may be a C₂₋₈ alkylene group, which may be straight or branched, such as ethylene, propylene, butylene, pentylene, hexylene, 2-ethyl hexylene, heptylene, 2,2-methyl, 1,3-propylene, 2-methyl 1,3 propylene or actylene. The diols having a methyl group at the 2 position of an alkylene chain may be used. Exemplary dials include ethane diol, propane diol, butane diol, pentane diol, hexane diol, 2 ethyl hexane diol, heptane diol, octane did, neopentyl glycol (2,2-methyl, 1,3-propane diol), 2-methyl 1,3 propane diol, 2-butyl-1,3-propane diol, 2-ethyl-1,3-propane diol and 1,4-cyclohexanal. The polyol may correspond to formula 9

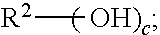

and the dial may correspond to formula 10: HO—R²—OH
wherein R² is separately in each occurrence a hydrocarbylene group having two or more bonds to the hydroxyl groups of a polyol. R² may be separately in each occurrence alkylene, alkenylene, cycloalkylene, heterocyclylene, alkyl heterocyclylene, arylene, aralkylene, alkarylene, heteroarylene, alkyl heteroarylene, or polyoxyalkylene. R² may be separately in each occurrence C₁-C₁₅ alkylene, C₂-C₁₅ alkenylene, C₃-C₉ cycloalkylene, C₂₋₂₀ heterocyclylene, C₃₋₂₀ alkheterocyclylene, C₈₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The recited groups may be substituted with one or more substituents that do not interfere with the transesterification reaction. Exemplary substituents include halo, alkylthio, alkoxy, hydroxyl, nitro, azido, cyano, acyloxy, carboxy, or ester. R² may be separately in each occurrence a C₂₋₈ alkylene group, such as ethylene, propylene, butylene, pentylene, hexylene, 2-ethyl hexylene, heptylene, 2-methyl 1,3 propylene or octylene. Exemplary C₃-C₉ cycloalkylenes include cyclohexylene. The alkylene groups may be branched or straight and may have a methyl group on the 2 carbon. Among preferred alkyl arylene polyols are polyols with the structure of -aryl-alkyl-aryl- (such as -phenyl-methyl-phenyl- or -phenyl-propyl-phenyl-) and the like. Among preferred alkyl cycloalkylene poly-yls are those with the structure of -cycloalkyl-alkyl-cycloalkyl- (such as -cyclohexyl-methyl-cyclohexyl- or -cyclohexyl-propyl-cyclohexyl-) and the like. The polyalkylene oxy groups may have alkylene groups of ethylene, propylene or butylene and the butylene groups may be derived from butylene oxides or tetrahydrofuran. c may be an integer of 8 or less, 6 or less, 4 or less or 3 or less. c may be an integer of 2 or greater or 3 or greater.

The one or more dihydrocarbyl dicarboxylates are compounds with two ester groups having a hydrocarbylene group disposed between the ester groups. The one or more dihydrocarbyl dicarboxylates comprise one or more of aromatic dicarboxylates, aliphatic dicarboxylates and cycloaliphatic dicarboxylates or may one or more dihydrocarbyl dicarboxylates wherein one of the hydrocarbyl groups is aliphatic, cycloaliphatic or aromatic and the other may be selected from another class of aliphatic, cycloaliphatic or aromatic group. The one or more dihydrocarbyl dicarboxylates comprise one or more of aromatic dicarboxylates having 8 to 14 carbon atoms in the backbone, aliphatic dicarboxylates having 1 to 12 carbon atoms in the backbone and cycloaliphatic dicarboxylates having 8 to 12 carbon atoms in the backbone. The one or more dihydrocarbyl dicarboxylates comprise one or more malonates, terephthalates, phthalates, isophthalates, naphthalene-2,6-dicarboxylates, 1,3-pheny-lenedioxy diacetates, cyclo-hexanedicarboxylates, cyclohexanediacetates, diphenyl-4,4′-dicarboxylates, succinates, glutarates, adipates, azelates, sebacates, or mixtures thereof. The one or more dihydrocarbyl dicarboxylates may comprise one or more malonates, isophthalates, terephthalates or sebacates. The one or more dihydrocarbyl dicarboxylates may correspond to formula 11:

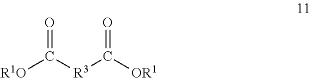

wherein R¹ is as previously described; and
R³ is separately in each occurrence a hydrocarbylene group having two bonds to the carbonyl groups of the diester wherein the hydrocarbylene group may contain one or more heteroatoms. R³ may be separately in each occurrence arylene, cycloalkylene, alkylene or alkenylene. R³ may be separately in each occurrence C₈₋₁₄ arylene, C₈₋₁₂ cycloalkylene, C₁₋₁₂ alkylene or C₂₋₁₂ alkenylene.

The multifunctional monomers may be prepared from 1,1-diester-1-alkenes and polyols, including diols. Multifunctional monomers comprise a polyol wherein at least two of the hydroxyl groups are replaced by the residue of 1,1-diester-1-alkenes. Where there are greater than two hydroxyl groups on the polyol it is possible that not all hydroxyl groups react with 1,1-diester-1-alkenes. It is desirable to react substantially all the hydroxyl groups with the 1,1-diester-1-alkenes. The alternatives discussed hereinbefore for the polyols and 1,1-diester-1-alkenes as far as structure are also applicable to the multifunctional monomers. Where a polyol with 3 or greater hydroxyl groups are used to prepare the multifunctional monomers they correspond to formula 12

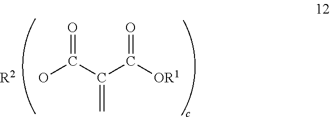

and
where a diol is used to initiate the multifunctional monomers they correspond to formula 13;

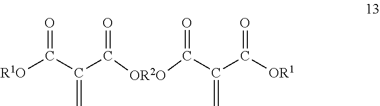

wherein R¹, R² and c are as defined hereinbefore. The multifunctional monomers can be prepared as disclosed hereinafter and as disclosed in Malofsky US 2014/0329980 and in Sullivan U.S. Pat. No. 9,416,091, both incorporated herein in their entirety for all purposes.

Another intermediate which may be used in the preparation of polyester macromers is one or more compounds comprising the one or more dihydrocarbyl dicarboxylates having the residue of a polyol, such as a diol, bonded to each of the carbonyl groups. These compounds may be referred to a polyol capped dihydrocarbyl dicarboxylates. Some of them may be called diol capped dihydrocarbyl dicarboxylates. Each ester group of the dihydrocarbyl dicarboxylates is subjected to transesterification to replace the hydrocarbyl groups with polyols, such as diols. The resulting polyol capped dihydrocarbyl dicarboxylates have terminal hydroxyl groups. The polyol capped dihydrocarbyl dicarboxylates may correspond to formula 14;

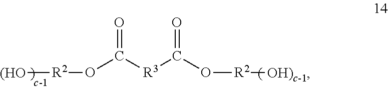

and
the diol capped dihydrocarbyl dicarboxylates may correspond to formula 15;

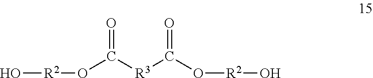

wherein R², R³ and c are as described hereinbefore. In this context the hydrocarbylene of R³ is bonded to the carbonyl groups of the residue of a diester in the polyol capped dihydrocarbyl dicarboxylates.

The polyester macromers may comprise or include mixtures of compounds formed in the preparation of the polyester macromers. Other ingredients may be added to the mixtures of compounds formed in the preparation of the polyester macromers Polyester macromer compositions may comprise i) a plurality of polyester macromers disclosed herein; ii) one or more multifunctional monomers containing the residue of one or more polyols and one or more 1,1-diester-1-alkenes, wherein the multifunctional monomers have substantially all of the hydroxyl groups of the polyols replaced with the 1,1-diester-1-alkenes; and iii) one or more 1,1-diester-1-alkenes. Each of these ingredients are disclosed hereinbefore. This composition can be taken from the reaction mixture formed when the polyester macromers are prepared. The resulting reaction mixture can be subjected to a separation process, such as distillation to remove an excess one or more of the more volatile species, such as alcohols, polyols or unreacted dihycrocarbyl dicarboxylates, to achieve the desired concentrations of components. One or more of the recited compounds may be added to achieve the desired component concentrations. Plurality with respect to the polyester macromers mean that a number of polyester macromer units which may be the same or different polyester macromers are present. Any one or more of the polyester macromers disclosed herein may be used in the compositions. Polyester macromers containing the residue of one or more dihydrocarbyl dicarboxylates in the backbone may be utilized. Polyester macromers used in the compositions may comprise the residue of one or more polyols and one or more 1,1-diester-1-alkenes. The plurality of polyester macromers may be present in an amount of about 10 percent by weight or greater of the composition, about 30 percent by weight or greater or about 60 percent by weight or greater. The plurality of polyester macromers may be present in an amount of about 80 percent by weight or less of the composition, about 70 percent by weight or less or about 40 percent by weight or less. The multifunctional monomers may be present in an amount of about 5 percent by weight or greater of the composition, about 10 percent by weight or greater, about 20 percent by weight or greater or 30 percent by weight or greater. The multifunctional monomers may be present in an amount of about 50 percent by weight or less of the composition, about 40 percent by weight or less, about 30 percent by weight or less or about 20 percent by weight or less. The 1,1-diester-1-alkenes may be present in an amount of about 0 percent by weight or greater of the composition, about 1 percent by weight or greater, about 5 percent by weight or greater, about 10 percent by weight or greater or about 20 percent by weight or greater. The 1,1-diester-1-alkenes may be present in an amount of about 40 percent by weight or less of the composition, about 30 percent by weight or less or about 20 percent by weight or less. The one or more polyols may be diols. The multifunctional monomer may be a difunctional monomer.

The polyester macromers may contain a volatile solvent. The volatile solvent may be any solvent that does not react with the components or interfere in the curing of the compositions. The solvents may be volatile at about 50° C. or greater. The solvents may be volatile polar solvents or volatile polar aprotic solvents. The polar solvent may volatilize away from the other components once the composition is applied to a substrate. Any polar solvent which volatilizes away from the other components once applied to the surface of a substrate may be utilized herein. The polar solvents may exhibit a boiling point of about 100° C. or greater, about 110° C. or greater or about 130° C. or greater. The polar solvents may exhibit a boiling point of about 200° C. or less, about 190° C. or less or about 170° C. or less. The polar solvent may be an alkylene glycol ether, an acetate modified alkylene glycol ether, a ketone, or a mixture of any of these solvents, and the like. The volatile solvents are present in sufficient amount to facilitate use of the compositions as desired, that is, the solvents facilitate delivery of the compositions and allow wet-out of the composition on a surface. The volatile solvents may be present in an amount of about 0 percent by weight or greater of the composition, about 1 percent by weight or greater, about 5 percent by weight or greater, about 10 percent by weight or greater or about 20 percent by weight or greater. The volatile solvents may be present in an amount of about 50 percent by weight or less of the composition, about 40 percent by weight or less of the composition, about 20 percent by weight or less or about 10 percent by weight or less.

The polymers crosslinked are polymers having polymer chains prepared from monomers having unsaturated groups and functional groups which are nucleophilic groups or mixtures of monomers having unsaturated groups and monomers having unsaturated groups and functional groups which are nucleophilic. The polymers crosslinked may be polymers having polymer chains prepared from monomers having unsaturated groups and functional groups which are nucleophilic groups. The polymers crosslinked may be polymers having polymer chains prepared from mixtures of monomers having unsaturated groups and monomers having unsaturated groups and functional groups which are nucleophilic. Monomers having unsaturated groups comprise compounds that contain unsaturation in their backbone wherein the unsaturation is capable of polymerization via free radical or anionic polymerization. The monomers having unsaturated groups may comprise one or more of 1,1-dicarbonyl-1-alkenes (as disclosed herein) acrylates, methacrylates, acrylamides, methacrylamides, unsaturated nitriles, vinyl esters, vinylidene substituted aromatic compounds, olefins, isocyanates, conjugated dienes, vinyl monomers, IN-vinyl pyrollidone; allyl methacrylate, vinyl toluene, vinyl benzophenone, diallyl phthalate, 1,3-butylene, glycol dimethacrylate, 1,6-hexanedioldiacrylate, and divinyl benzene. Exemplary vinyl esters include vinyl acetate and vinyl propionate. Exemplary vinyl monomers include vinyl chloride, vinylidene chloride and N-vinyl pyrollidone. Exemplary conjugated dienes include butadiene and isoprene, Unsaturated nitriles include, but are not limited to, acrylonitrile, methacrylonitrile, ethacrylonitrile, fumaronitrile and mixtures thereof. The unsaturated nitrile may be acrylonitrile. The use of the term “(meth)” followed by another term such as acrylate, acrylonitrile, or acrylamide, as used throughout the disclosure, refers to both acrylate, acrylonitrile, or acrylamide and methacrylate, methacrylonitrile, or methacrylamide,

Vinylidene substituted aromatic monomers comprise vinylidene, alkenyl groups, bonded directly to aromatic structures. The vinylidene substituted aromatic monomers may contain one or more aromatic rings, may contain one or two aromatic rings, or may contain one aromatic ring. The aromatic rings can be unsubstituted or substituted with a substituent that does not interfere with polymerization of the vinylidene substituted aromatic monomers, or the fabrication of the polymers formed into desired structures. The substituents may be halogens or alkyl groups, such as bromine, chlorine or C₁ to C₄ alkyl groups; or a methyl group. Alkenyl groups comprise straight or branched carbon chains having one or more double bonds, or one double bond. The alkenyl groups useful for the vinylidene substituted aromatic monomers may include those that when bonded to an aromatic ring are capable of polymerization to form copolymers. The alkenyl groups may have 2 to 10 carbon atoms, 2 to 4 carbon atoms or 2 carbon atoms. Exemplary vinylidene substituted aromatic monomers include styrene, alpha methyl styrene, N-phenyl-maleimide and chlorinated styrenes; or alpha-methyl styrene and styrene. The vinylidene substituted aromatic monomers may be mono-vinylidene aromatic monomers, which contain one unsaturated group. Vinylidene aromatic monomers include but are not limited to those described in U.S. Pat. Nos. 4,666,987; 4,572,819 and 4,585,825, which are herein incorporated by reference.

(Meth) acrylate as used herein refers to compounds having a vinyl group bonded to the carbonyl moiety of an alkyl ester wherein the carbon of the vinyl group bonded to the carbonyl group further has a hydrogen or a methyl group bonded thereto. The term (meth) as used in this context refers to compounds having either of a hydrogen or methyl group on the carbon of the vinyl group bonded to the carbonyl group. (Meth)acrylates useful include those that correspond to the formula 16:

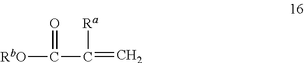

wherein R^{a} is separately in each occurrence H or —CH3; and R^{b} may be a C 1 to C-30 alkyl group or C 1-10 alkyl group wherein the alkyl group may contain a nucleophilic group as described herein. Examples of the one or more (meth)acrylates include lower alkyl (meth)acrylates, such as methyl (meth)acrylate, ethyl (meth)acrylate, propyl (meth)acrylate, butyl (meth)acrylate, pentyl (meth)(acrylate) and hexyl (meth) acrylate; hydroxyethyl methacrylate, hydroxypropyl methacrylate, aminoalkyl (meth)acrylate, N-alkyl aminoalkyl (meth)acrylate, N,N-dialkyl aminoalkyl (meth)acrylate; urieido (meth)acrylate; (meth)acrylonitrile and (meth)acrylamide. The polymers crosslinked contain nucleophilic groups. The nucleophilic groups may be pendant from the polymer chain. The polymers formed may contain the residue of one or more monomers having unsaturated groups and functional groups which are nucleophilic groups. The polymers may be polymers prepared from one or more monomers having unsaturated groups and functional groups which are nucleophilic groups. The polymers maybe copolymers of one or more unsaturated monomer and one or more unsaturated compounds containing one or more nucleophilic groups which comprise the addition reaction product of one or more unsaturated monomers and one or more unsaturated monomers containing one or more nucleophilic groups. The unsaturated monomers containing one or more nucleophilic groups useful are those which can polymerize under free radical or anioinic polymerization conditions. The one or more unsaturated monomers containing one or more nucleophilic groups may contain one nucleophilic group. The copolymers may contain more than one different nucleophilic group or may contain only one species of nucleophilic group. The copolymers may be prepared from more than one unsaturated compound each containing different type of nucleophilic group. The copolymers may be prepared from one species of unsaturated compounds each containing the same nucleophilic group. The one or more copolymers of one or more unsaturated monomers and one or more unsaturated monomers containing one or more nucleophilic groups may contain a mixture of copolymers that contain polymer chains of differing amounts of nucleophilic groups.

The one or more unsaturated compounds containing nucleophilic groups may contain any nucleophilic group that reacts with compounds containing two or more 1,1-dicarbonyl 1-alkene groups. Nucleophilic group as used herein is a group which donates an electron pair to make a covalent bond. Exemplary nucleophilic groups include carboxylic acid, alcohol, phenol, hydroxyl, amine, aniline, imidazole, tetrazole, thiol, boronic acid, glycol, hydrazine, hydroxyl amine benzoic acids, sulfonates, and sulfates and the like. Exemplary nucleophilic groups include hydroxyl, carboxylic acids, amines, benzoic acids, sulfonates, and sulfates and the like. Nucleophilic groups may be carboxylic acid groups. The one or more unsaturated compounds containing nucleophilic groups may be (meth) acrylic acids, (meth)acrylates, hydroxyalkyl methacrylates, and the like. The one or more unsaturated compounds containing nucleophilic groups may be methacrylic acid and or acrylic acid. The monomers having unsaturated groups and functional groups which are nucleophilic may comprise one or more (meth)acrylates, one or more acrylamides, (meth)acrylic acids, unsaturated anhydrides and the like. The monomers having unsaturated groups and functional groups which are nucleophilic may comprise one or more of methacrylic acid, acrylic acid, ethylene acrylic acid, maleic anhydride, 2-Acrylamido-2-methylpropanesulfonic acid, and acetoacetoxyethyl methacrylate.

The amount of one or more unsaturated monomers containing one or more nucleophilic groups is selected to provide the desired level of crosslinking. The amount of the monomers containing the nucleophilic groups on the one or more copolymers of one or more unsaturated monomers and one or more unsaturated compounds containing a nucleophilic group may be about 0.1 percent by weight of the copolymer or greater based on the weight of the copolymer, about 0.5 percent by weight about 1.0 percent by weight or greater or about 5 percent by weight or greater. The concentration of the one or more unsaturated monomers containing one or more nucleophilic groups on the one or more copolymers of one or more unsaturated monomers and one or more unsaturated compounds containing nucleophilic groups may be about 30 percent by weight of the copolymer or less greater based on the weight of the copolymer, about 20 percent by weight or less or about 15 percent by weight or less. The copolymers of one or more unsaturated monomers and one or more unsaturated monomers containing a nucleophilic group may contain unsaturated monomers in an amount of about 50 percent by weight or greater of the copolymers, about 80 percent by weight or greater or about 90 percent by weight or greater. The copolymers of one or more unsaturated monomers and one or more unsaturated compounds containing a nucleophilic group may contain unsaturated monomers in an amount of about 99.5 percent by weight of the copolymers or less, about 99 percent by weight or less, 85 percent by weight or less, 80 percent by weight or less or about 70 percent by weight or less. The copolymers may contain one or more of the unsaturated monomers disclosed herein. The polymer chains alternatively can be any polymers dispersed in water which contain functional groups which are nucleophilic, such as polyolefin dispersions, alkyd dispersions, polyurethane dispersions and epoxy-based dispersions.

The monomers may further contain other components to stabilize the compositions prior to exposure to polymerization conditions or to adjust the properties of the final polymer for the desired use. For example, a suitable plasticizer can be included with a reactive composition. Exemplary plasticizers are those used to modify the rheological properties of adhesive systems including, for example, straight and branched chain alkyl-phthalates such as diisononyl phthalate, dioctyl phthalate, and dibutyl phthalate, trioctyl phosphate, epoxy plasticizers, toluene-sulfamide, chloroparaffins, adipic acid esters, sebacates such as dimethyl sebacate, castor oil, xylene, 1-methyl-2-pyrrolidone and toluene. Commercial plasticizers such as HB-40 partially hydrogenated terpene manufactured by Solutia Inc. (St. Louis, Mo.) can also be suitable. For example, one or more dyes, pigments, toughening agents, impact modifiers, rheology modifiers, natural or synthetic rubbers, filler agents, reinforcing agents, thickening agents, opacifiers, inhibitors, fluorescence markers, thermal degradation reducers, thermal resistance conferring agents, surfactants, wetting agents, or stabilizers can be included in a polymerizable system. For example, thickening agents and plasticizers such as vinyl chloride terpolymer (comprising vinyl chloride, vinyl acetate, and dicarboxylic acid at various weight percentages) and dimethyl sebacate respectively, can be used to modify the viscosity, elasticity, and robustness of a system. The thickening agents and other compounds can be used to increase the viscosity of a polymerizable system from about 1 to 3 cPs to about 30,000 cPs, or more.

Stabilizers can be included in the monomers to increase and improve the shelf life and to prevent spontaneous polymerization. One or more anionic polymerization stabilizers and or free-radical stabilizers may be added to the compositions. Anionic polymerization stabilizers are generally electrophilic compounds that scavenge bases and nucleophiles from the composition or growing polymer chain. The use of anionic polymerization stabilizers can terminate additional polymer chain propagation. Exemplary anionic polymerization stabilizers are acids, exemplary acids are carboxylic acids, sulfonic acids, phosphoric acids and the like. Exemplary stabilizers include liquid phase stabilizers, such as methanesulfonic acid (“MSA”), and vapor phase stabilizers, such as trifluoroacetic acid (“TFA”). Free-radical stabilizers may include phenolic compounds, such as 4-methoxyphenol or mono methyl ether of hydroquinone (“MeHQ”) and butylated hydroxy toluene (BHT)). Stabilizer packages for 1,1-disubstituted alkenes are disclosed in Malofsky et al., U.S. Pat. No. 8,609,885 and Malofsky et al., U.S. Pat. No. 8,884,051. Additional free radical polymerization inhibitors are disclosed in Sutoris et al., U.S. Pat. No. 6,458,956. Minimal quantities of a stabilizer are needed and, only about 150 parts-per-million or less may be included. A blend of multiple stabilizers may be included such as, for example a blend of anionic stabilizers (MSA) and free radical stabilizers (MeHQ). The one or more anionic polymerization stabilizers are present in sufficient amount to prevent premature polymerization. The anionic polymerization stabilizers may be present in an amount of about 0.1 part per million or greater based on the weight of the monomers, about 1 part per million by weight or greater or about 5 parts per million by weight or greater. The anionic polymerization stabilizers may be present in an amount of about 1000 parts per million by weight or less based on the weight of the monomers, about 500 parts per million by weight or less or about 100 parts per million by weight or less. The one or more free radical stabilizers may be present in sufficient amount to prevent premature polymerization. The free radical polymerization stabilizers may be present in an amount of about 1 parts per million or greater based on the weight of the monomers, about 5 parts per million by weight or greater or about 10 parts per million by weight or greater. The free radical polymerization stabilizers may be present in an amount of about 5000 parts per million by weight or less based on the weight of the monomers, about 1000 parts per million by weight or less or about 500 parts per million by weight or less.

The polymers having polymer chains prepared from monomers having unsaturated groups and functional groups which are nucleophilic groups or mixtures of monomers having unsaturated groups and monomers having unsaturated groups and functional groups which are nucleophilic may be prepared by any conventional process for preparing addition polymers via free radical polymerization or anionic polymerization. Examples of these known polymerization processes include bulk, mass-solution, or mass-suspension polymerization, generally known as mass polymerization processes. For a good discussion of how to make monovinylidene aromatic copolymer containing compositions see “Modern Styrenic Polymers” of Series In Polymer Science (Wiley), Ed. John Scheirs and Duane Priddy, ISBN 0 471 497525. Also, for example, U.S. Pat. Nos. 3,660,535; 3,243,481; and 4,239,863, which are incorporated herein by reference.

The copolymers may be prepared by emulsion polymerization. The polymerization techniques used to prepare the copolymers are well known in the art. The copolymers may be formed in an emulsion containing one or more surfactant. Surfactants which can be used include natural or synthetic substances which, in water, lower the surface tension of the water or of other liquids. Surfactants which can be used include anionic, cationic, nonionic, and ampholytic surfactants or mixtures thereof. The polymerization process includes one or more surfactants for forming an emulsion having micelles or a discrete phase including monomers distributed throughout a continuous phase of water. The surfactant may be an emulsifier, a defoamer, or a wetting agent. The surfactant may include an ionic surfactant, an amphoteric surfactant, a nonionic surfactant, or any combination thereof. The surfactant may be present in a sufficient quantity so that a stable emulsion is formed by mixing or otherwise agitating a system including the monomers and water. The amount of surfactant needed may as little as necessary to provide some charge to the polymer surface. The surfactants according to the teachings herein include one or more surfactants for improving the stability of the suspension, such as for improving the stability of the dispersed phase in the water. The amount of surfactant provides colloidal stability to the polymerizing and polymerized particles.

Surfactants that may be employed include alkyl polysaccharides, alkylamine ethoxylates, amine oxides, castor oil ethoxylates, ceto-oleyl and salts thereof, ceto-stearyl and salts thereof, decyl alcohol ethoxylates, dinonyl phenol ethoxylates, dodecyl phenol ethoxylates, end-capped ethoxylates, ethoxylated alkanolamides, ethylene glycol esters, fatty acid alkanolamides, fatty alcohol alkoxylates, lauryl and salts thereof, mono-branched, nonyl phenol ethoxylates, octyl phenol ethoxylates, random copolymer alkoxylates, sorbitan ester ethoxylates, stearic acid ethoxylates, synthetic, tall oil fatty acid ethoxylates, tallow amine ethoxylates, alkyl ether phosphates and salts thereof, alkyl phenol ether phosphates, alkyl phenol ether sulfates and salts thereof, alkyl naphthalene sulfonates and salts thereof, condensed naphthalene sulfonates and salts thereof, aromatic hydrocarbon sulphonic acids and salts thereof, fatty alcohol sulfates and salts thereof, alkyl ether carboxylic acids and salts thereof, alkyl ether sulfates and salts thereof, mono-alkyl sulphosuccinamates, di-alkyl sulphosuccinates, alkyl phosphates and salts thereof, alkyl benzene sulphonic acids and salts thereof, alpha olefin sulfonates and salts thereof, condensed naphthalene sulfonates and salts thereof, polycarboxylates and salts thereof, alkyl dimethylamines, stearic acid and salts thereof alkyl amidopropylamines, sulfonic acid and salts thereof, stearic acids and salts thereof, quaternized amine ethoxylates, quaternary ammonium compounds, and mixtures or combinations thereof.

Non-limiting examples of amphoteric surfactants that may be employed include amine oxide surfactants, sultaine surfactants, betaine surfactants, or any combination thereof. Sultaine and betaine surfactants may include hydroxysultaines and hydroxybutaines. Exemplary amphoteric surfactants that may be employed include cocamine oxide, cocoamidopropylamine oxide, cetamine oxide, decylamine oxide, lauramine oxide, myristylamine oxide, cetyl amine oxide, steramine oxide, cocamidopropyl hydroxysultaine, capryl/capramidopropyl betaine, cocamidopropyl betaine, cetyl betaine, cocamidopropyl betaine, laurylamidopropyl betaine, or any combination thereof. Non-limiting examples of cationic surfactants include quaternary ammonium chloride surfactants, quaternary ammonium methyl sulfate surfactants, ester quaternarie surfactants, or any combination thereof. Without limitation, exemplary cationic surfactants that may be employed include cetrimonium chloride, stearalkonium chloride, olealkonium chloride, stearamidopropalkonium chloride, alkyl dimethyl benzyl ammonium chlorides, alkyl dimethyl ethylbenzyl ammonium chlorides, didecyl dimethyl ammonium chloride, dialkyl dimethyl ammonium chloride, benzalkonium chloride, methyl bis(hydrogenated tallow amidoethyl)-2-hydroxyethyl ammonium methyl sulfate, methyl bis(tallowamido ethyl)-2-hydroxyethyl ammonium methyl sulfate, methyl bis(tallowamido ethyl)-2-tallow imidazolinium methyl sulfate, dialkyl ammonium methosulfate, dialkylester ammonium methosulfate, dipalmitoylethyl hydroxyethylammonium methosulfate, dialkyl ammonium methosulfate, dialkylester ammonium methosulfate, methyl bis[ethyl(tallowate)]-2-hydroxyethyl ammonium methyl sulfate, methyl bis[ethyl(tallowate)]-2-hydroxyethyl ammonium methyl sulfate, or any combination thereof. Non-limiting examples of nonionic surfactants include alkoxylate surfactants, amide surfactants, ester surfactants, ethoxylate surfactants, lactate surfactants, triglyceride surfactants, or any combination thereof, exemplary nonionic surfactants that may be employed include polyalkoxylated alphatic bases, polyalkoxylated amides, alkylphenol alkoxylates, alkylphenol block copolymers, alkyl phenol ethoxylates, polyalkylene oxide block copolymers, glyceryl cocoate, alcohol alkoxylates, butyl based block copolymers, polyalkylene oxide block copolymer, N,N-dimethyldecanamide (N,N-dimethylcapramide), N,N-dimethyloctanamide (N,N-dimethylcaprylamide), fatty alkanolamides, oleyl diethanolamide, lauryl diethanolamide, coca diethanolamide, fatty diethanolamides, polyethylene glycol cocamides, polyethylene glycol lauramides, lauryl monoethanolamide, myristyl monoethanolamide, coco monoisopropanolamide, alkyl ether phosphates, phosphate esters, glyceryl monostearate, glycerol monooleate, polyglyceryl decaoleates, polyglycerol esters, polyglycerol polyricinoleates, neutralized alcohol phosphates, capric triglyceride, caprylic triglyceride, tridecyl alcohol phosphate ester, nonylphenol ethoxylate phosphate ester, trimethylopropane tricaprylate tricaprate polyol ester, methyl caprylate/caprate, methyl laurate, methyl myristate, methyl palmitate, methyl oleate, alcohol phosphates, trimethylolpropane tricaprylate/caprate polyol ester, pentaerythritol tricaprylate/caprate polyol ester, pentaerythrityl tetracaprylate/tetracaprate, nonylphenol phosphate ester, phosphate esters of an alkyl polyethoxyethanol, canola oil methyl ester, soybean oil methyl ester, pentaerythritol tetracaprylate/caprate, trimethylolpropane tricaprylate/caprate, amine neutralized phosphate ester, fatty alkyl ethoxylates, alcohol ethoxylates, fatty acid ethoxylates, tallow amine ethoxylates, octyl phenol ethoxylates, nonyl phenol ethoxylate, castor oil ethoxylate, polyalkoxylated alphatic bases, polyalkoxylated amides, octyl phenol ethoxylate, tristyrylphenol ethoxylate, ammonium salt of ethoxylated polyarylphenol sulfates, tristyrylphenol ethoxylate phosphate ester, potassium salt of tristyrylphenol ethoxylate phosphate ester, ethoxylated coco amine, sorbital trioleate ethoxylate, sorbital monooleate ethoxylate, lauryl lactyl lactate, capric triglyceride, caprylic triglyceride, hydrogenated vegetable oil, or any combination thereof.

Exemplary surfactants include ethoxylates, such as an ethoxylated did. The surfactant may include 2,4,7,9-tetramethyl-5-decyne-4,7-diol ethoxylate. The surfactant may include a poly(alkene glycol). The surfactant may be a poly(ethylene glycol)-block-poly(propylene glycol)-block-poly(ethylene glycol) copolymer. The surfactant may include including an alcohol, an ethoxylated alcohol, or both. The surfactant may include CARBOWET® 138 nonionic surfactant (including alkyl alcohol, polyethylene glycol, ethoxylated C9-C11 alcohols). Another exemplary surfactant is a surfactant including a sorbitan, a sorbitol, or a polyoxyalkene, such as sorbitan monopalmitate (nonionic surfactant). Exemplary surfactants include branched polyoxyethylene (12) nonylphynyl ether (IGEPAL® CO-720) and poly(ethylene glycol) sorbitol hexaoleate (PEGSH),

Exemplary surfactants include compounds of formula 17:

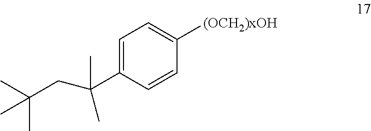

wherein x is an integer between 7 and 40 or x is 7-8, 9-10, or 40. The surfactant may be Triton X-405.

The compositions polymerized may contain branching agents commonly used in preparing addition polymers. The branching agents may be unsaturated compounds containing two or more unsaturated groups such as vinylidene substituted aromatic monomers having 2 or more vinylidene groups. Other branching agents may include other difunctional and in general multifunctional (functionality >2) monomers, multifunctional initiators and multifunctional chain transfer agents and the like. The branching agents may be present in polymerizable compositions in an amount of about 0.001 percent by weight of the composition or greater, about 0.002 percent by weight or greater or about 0.003 percent by weight or greater. The branching agents may be present in polymerizable compositions in an amount of about 0.5 percent by weight of the composition or less, about 0.2 percent by weight or less or about 0.1 percent by weight or less.

Compositions containing the polymers may contain impact modifiers. The terms impact modifiers and rubbers are used interchangeably herein. Various impact modifiers may be used in the compositions disclosed; such as diene rubbers, ethylene propylene rubbers, ethylene propylene diene (EPDM) rubbers, ethylene copolymer rubbers, acrylate rubbers, polyisoprene rubbers, silicon rubbers, silicon-acrylate rubbers, polyurethanes, thermoplastic elastomers, halogen containing rubbers, and mixtures thereof. Also suitable are inter-polymers of rubber-forming monomers with other copolymerizable monomers. The rubbers may be present in the formulated composition in sufficient amount to provide the desired impact properties to the composition. Desired impact properties include increased izod, charily, gardner, tensile, falling dart, and the like. The rubbers may be diene rubbers such as polybutadiene, polyisoprene, polypiperylene, polychloroprene, and the like or mixtures of diene rubbers, that is, any rubbery polymers of one or more conjugated 1,3-dienes, such as 1,3-butadiene. The impact modifiers may be included at during polymerization or blended with the copolymers thereafter.

In preparing the polymers having polymer chains prepared from monomers having unsaturated groups and functional groups which are nucleophilic groups or mixtures of monomers having unsaturated groups and monomers having unsaturated groups and functional groups which are nucleophilic the monomers and other additives may be contacted and subjected to known polymerization processes.

Where the copolymers are prepared by emulsion polymerization, the monomers are dispersed in water with a surfactant. The method may comprise contacting water and a surfactant to form a micellar dispersion and adding to the micellar dispersion one or more polymerization initiators and monomers having unsaturated groups and functional groups which are nucleophilic or mixtures of monomers having unsaturated groups and monomers having unsaturated groups and functional groups which are nucleophilic to form polymers with polymer chains. The amount of surfactant chosen is that amount that forms a stable emulsion and facilitates formation of the copolymer. The concentration of the surfactant may be about 0.001 weight percent or more, about 0.01 weight percent or more, about 0.1 weight percent or more or about 0.5 weight percent or more, based on the total weight of the emulsion. The concentration of the surfactant may be about 15 weight percent or less, about 10 weight percent or less, about 6 weight percent or less, or about 3 weight percent or less, based on the total weight of the emulsion. The dispersion of the monomers in water may be achieved with an appropriate form of agitation. Polymerization of the monomers may be improved by adjusting the pH of the dispersion. Any pH of the dispersion which enhances the polymerization may be used. The pH of the emulsion may be about 4 or greater or about 7 or greater; about 4 to about 10; or about 7 to about 10.

A redox initiation process may be used to prepare the copolymers. The reaction temperature may be maintained at a temperature lower than 100° C. throughout the course of the reaction. The reaction temperature may be from about 30° C. to about 95° C. or from about 50° C. to about 90° C. The monomer mixture may be added neat or as an emulsion in water. The monomer mixture may be added in one or more additions or continuously, linearly or not, over the reaction period, or combinations thereof. The redox system includes an oxidant and a reductant. One or more oxidants such as, for example, hydrogen peroxide, sodium peroxide, potassium peroxide, t-butyl hydroperoxide, t-amyl hydroperoxide, cumene hydroperoxide, ammonium and/or alkali metal persulfates, sodium perborate, perphosphoric acid and salts thereof, potassium permanganate, and ammonium or alkali metal salts of peroxydisulfuric acid, typically at a level of 0.01 percent to 3.0 percent by weight, based on dry polymer weight, may be used. Exemplary reductants include sodium sulfoxylate formaldehyde, alkali metal and ammonium salts of sulfur-containing acids, such as sodium sulfite, bisulfite, thiosulfate, hydrosulfite, sulfide, hydrosulfide or dithionite, formadinesulfinic acid, hydroxymethanesulfonic acid, acetone bisulfite, amines such as ethanolamine, glycolic acid, glyoxylic acid hydrate, ascorbic acid, isoascorbic acid, lactic acid, glyceric acid, malic acid, 2-hydroxy-2-sulfinatoacetic acid, tartaric add and salts of the preceding adds typically at a level of 0.01 percent to 3.0 percent by weight, based on dry polymer weight, may be used. Redox reaction catalyzing metal salts of iron, copper, manganese, silver, platinum, vanadium, nickel, chromium, palladium, or cobalt may optionally be used. The oxidant and reductant may be added to the reaction mixture in separate streams, which may be concurrently with the monomer mixture.

A chain transfer agent such as, for example, isopropanol, halogenated compounds, n-butyl mercaptan, n-amyl mercaptan, n-dodecyl mercaptan, t-dodecyl mercaptan, alkyl thioglycolate, mercaptopropionic acid, and alkyl mercaptoalkanoate in an amount of 0.001 to 0.05, or about 0.0025 to 0.05 moles per kg dry polymer weight, may be used. Linear or branched C₄-C₂₂ alkyl mercaptans such as n-dodecyl mercaptan and t-dodecyl mercaptan may be used. Chain transfer agent(s) may be added in one or more additions or continuously, linearly or not, over most or all of the entire reaction period or during limited portion(s) of the reaction period such as, for example, in the kettle charge and in the reduction of residual monomer stage.

However, at least 40 percent by weight, at least 75 percent by weight, or at least 95 percent by weight, based on dry polymer weight, of the emulsion polymer is formed by redox polymerization in the presence of 0.001 to 0.05 moles chain transfer agent per kg dry polymer weight. By “at least 40 percent by weight, based on dry polymer weight, of the emulsion polymer is formed by redox polymerization in the presence of 0.001 to 0.05 moles chain transfer agent per kg dry polymer weight” is meant herein that at least 40 percent by weight, based on dry polymer weight, of the emulsion polymer is formed by redox emulsion polymerization and that this polymerization is effected contemporaneously with the prior presence and/or addition of a total of 0.001 to 0.05 moles chain transfer agent per kg dry polymer weight. The emulsion polymerization is contemplated to include embodiments where some of the polymer is introduced by a polymer seed, formed in situ or not, or formed during hold periods or formed during periods wherein the monomer feed has ended, and residual monomer is being converted to polymer.

The emulsion polymer may be prepared by a multistage emulsion polymerization process, in which at least two stages differing in composition are polymerized in sequential fashion. Such a process usually results in the formation of at least two mutually incompatible polymer compositions, thereby resulting in the formation of at least two phases within the polymer particles. Such particles are composed of two or more phases of various geometries such as, for example, core/shell or core/sheath particles, core/shell particles with shell phases incompletely encapsulating the core, core/shell particles with a multiplicity of cores, and interpenetrating network particles. In all of these cases the majority of the surface area of the particle will be occupied by at least one outer phase and the interior of the particle will be occupied by at least one inner phase. Each of the stages of the multi-staged emulsion polymer may contain the same monomers, surfactants, redox initiation system, chain transfer agents, etc. as disclosed herein-above for the emulsion polymer. The polymerization techniques used to prepare such multistage emulsion polymers are well known in the art such as, for example, U.S. Pat. Nos. 4,325,856; 4,654,397; and 4,814,373. The emulsion polymerization may be performed for a time period wherein the desired polymer is prepared. The time period for the reaction may be ______ hours or greater, ______ hours or greater or ______ hours or greater. The time period for the reaction may be ______ hours or less, ______ hours or less or ______ hours or less.

The process disclosed may include the use of seeds to initiate formation of polymer particles. Any seed that enhances formation of particles may be utilized. Exemplary classes of seeds include those used in forming acrylate-based lattices and styrene based lattices. Exemplary seeds include silica nanoparticles and carboxylated latex cores, Carboxylated latex cores may be made by conventional emulsion polymerization.

During the polymerization process, a solution may be stirred, sonicated or otherwise agitated to create the solution. For example, a solution including the monomer, the solvent, surfactant and any polymer may be mixed at a rate of about 10 rpm or more, about 50 rpm or more, about 200 rpm or more, or about 1,000 rpm or more using other means of agitation, such as sonication. When using sonication, the frequency may be about 0.2 kHz or more, about 1 kHz or more, about 5 kHz or more, about 20 kHz or more or about 50 kHz or more. The frequency may be about 1000 kHz or less, about 500 kHz or less, about 200 kHz or less, or about 100 kHz or less.

The polymers may have a number average molecular weight or a weight average molecular weight that is about 3,000 g/mole or greater, about 50,000 g/mole or greater, about 200,000 g/mole or greater, about 300,000 g/mole or greater, about 500,000 g/mole or greater, about 750,000 g/mole or greater or about 900,000 g/mole or greater. The polymers may have a number average molecular weight or a weight average molecular weight that is about 1,000,000 Oriole or less, about 800,000 g/mole or less, about 600,000 g/mole or less and about 400,000 g/mole or less, about 100,000 g/mole, or less or about 25,000 g/mole.

The polymer particle size and/or particle size distribution (e.g., after the completion of polymerization) may be controlled based on process considerations, based on product control considerations, based on application requirements, or any combination thereof. For example, there may be a need for emulsion particles having a unimodal particle size distribution, a multi-modal particle size distribution (e.g., a bimodal distribution) or a narrow particle size distribution, or any combination thereof. The particle size distribution of the polymers prepared herein may about 10 nm or greater, about 100 nm or greater, about 300 nm or greater, about 600 nm or greater about 800 nm or greater. The particle size distribution of the polymers prepared herein may about 1 micron or less, about 700 nm or less, about 500 nm or less, about 300 nm or less about 100 nm or less or about 50 nm or less. Particle size is controlled by choice of polymerization conditions with emulsion or microemulsion conditions providing small particles and suspension and mini-emulsion polymers yielding large particles.

The resulting polymer may be characterized by a polydispersity index of greater than about 1.00 or about 1.05 or more. The resulting polymer may be characterized by a polydispersity index of about 20 or less, about 7 or less, about 4 or less or about 2.3 or less. The resulting polymer may have a narrow molecular weight distribution such that the polydispersity index is about 1.9 or less, about 1.7 or less, about 1.5 or less, or about 1,3 or less.

The polymers having polymer chains prepared from monomers having unsaturated groups and functional groups which are nucleophilic groups or mixtures of monomers having unsaturated groups and monomers having unsaturated groups and functional groups which are nucleophilic are crosslinked by compounds containing two or more 1,1-dicarbonyl 1-alkene groups. The two or more 1,1-dicarbonyl 1-alkene groups are contacted with the copolymers under conditions such that crosslinking occurs. The contacting may be in an emulsion after the copolymers are formed. The contacting may take place after the copolymer is removed from the emulsion. The copolymer may be in any form such that the two or more 1,1-dicarbonyl 1-alkene groups can be contacted with the copolymer or a portion thereof. Particles of the copolymer may be contacted with the two or more 1,1-dicarbonyl 1-alkene groups. Alternatively the copolymer may be applied to a substrate or formed into a structure, such as a sheet and contacted with two or more 1,1-dicarbonyl 1-alkene groups.

The polymer and the two or more 1,1-dicarbonyl 1-alkene groups may be contacted at any ratio such that the copolymer or a portion of the copolymer contacted with the compound with two or more 1,1-dicarbonyl 1-alkene groups crosslinks. The compound with two or more 1,1-dicarbonyl 1-alkene groups may be contacted with the polymer in an amount based on the weight of the polymer and the compound with two or more 1,1-dicarbonyl 1-alkene groups of from about 0.5 percent by weight or greater, about 1.0 percent by weight or greater or about 2.0 percent by weight or greater. The compound with two or more 1,1-dicarbonyl 1-alkene groups may be contacted with the polymer in an amount based on the weight of the polymer and the compound with two or more 1,1-dicarbonyl 1-alkene groups of about 15 percent by weight or less, or about 10 percent by weight or less. Below 1 percent, the improvement in properties of coatings prepared from the composition is not significant. Up to 15 percent by weight, the properties of coatings prepared from the composition show significant improvement. The compounds with two or more 1,1-dicarbonyl 1-alkene groups may be contacted with the polymers at about −40° C. or greater, about 0° C. or greater or about 20° C. or greater. The compounds with two or more 1,1-dicarbonyl 1-alkene groups may be contacted with the polymers at about 150° C. or less, or about 100° C. or less or about 50° C. or less. Slight overpressure may be used as well. The compounds with two or more 1,1-dicarbonyl 1-alkene groups may be contacted with the polymers for a time sufficient to result in crosslinking of the polymers or the desired portion of the polymers. The contacting time may be about 1 hour or greater, about 10 hours or greater or about 20 hours or greater. The contacting time may be about 70 hours or less.

Disclosed is a method comprising contacting a stabilized emulsion of polymers having polymer chains prepared from monomers having unsaturated groups and functional groups which are nucleophilic and mixtures of monomers having unsaturated groups and monomers having unsaturated groups and functional groups which are nucleophilic with compounds containing two or more 1,1-dicarbonyl alkene groups under conditions such that the polymer chains are crosslinked by compounds containing two or more 1,1-dicarbonyl alkene groups. The stabilized emulsion of polymers may be applied to the surface of a substrate and the water is allowed to evaporate away to deposit the polymers on the surface of the substrate so as to form a coherent coating. Thereafter the polymers on the surface of the substrate may be contacted with compounds with two or more 1,1-dicarbonyl 1-alkene groups under conditions to crosslink the polymer or a portion of the polymer. The contacting conditions are as disclosed herein.

The polymer compositions may contain one or more wetting agents which facilitate the application of such compositions to substrates. Any wetting and or levelling agent which enhances the application of the compositions to a substrate may be used. Exemplary classes of wetting agents include polyether modified polydi-methyl siloxanes, fluorinated hydrocarbons and the like. The wetting agents may be poly-ether modified polydimethyl siloxanes. The wetting and/or levelling agents are present in sufficient amount to facilitate application of the compositions to a substrates surface. The wetting agents may be present in an amount of about 0.01 percent by weight or greater of the composition, about 0.5 percent by weight or greater or about 1 percent by weight or greater. The wetting agents may be present in an amount of about 5 percent by weight or less of the composition, about 2 percent by weight or less or about 1 percent by weight or less. The formed compositions may further contain one or more UV stabilizers which inhibit the degradation of structures containing the polyester macromers. Any UV stabilizer which inhibits degradation due to exposure to UV radiation may be used. Exemplary classes of ultraviolet light stabilizers include benzophenones, benzotriazoles and hindered amines (commonly known as hindered amine light stabilizers (HALS). Exemplary UV light stabilizers include Cyasorb UV-531 2-hydroxy-4-n-octoxybenzophenone, Tinuvin 571 2-(2H-benzotriazol-2-yl)-6-dodecyl-4-methylphenol, branched and linear Tinuvin 1,2,3 bis-(1-octyloxy-2,2,6,6, tetramethyl-4-piperidinyl) sebacate and Tinuvin 765, bis(1,2,2,6,6,-pentamethyl-4-piperidinyl) sebacate. The UV light stabilizers are present in sufficient amount to enhance long-term durability of the compositions containing polyester macromers. The UV light stabilizers should be selected so as to not affect the stability or pot life of the composition by premature polymerization, either by initiating or catalyzing free radical polymerization, anionic polymerization or Michael addition across the alkene double bond. The UV light stabilizers may be present in an amount of about 0.01 percent by weight or greater of the composition, about 0.1 percent by weight or greater or about 0.2 percent by weight or greater. The UV light stabilizers may be present in an amount of about 5 percent by weight or less of the composition, about 3 percent by weight or less, about 2 percent by weight or less or about 1 percent by weight or less. The composition may further comprise defoamers and/or deaerators. The compositions may foam during processing which can cause problems with respect to surface and appearance of a coating. Any defoamer and/or deaerator which prevents foaming or the formation of bubbles and which does not negatively impact the properties of the composition may be used. Exemplary defoamers are silicone defoamers, silicone free defoamers, polyacrylate defoamers, mixtures thereof and the like. Exemplary de-foamers include FOAM BLAST™ 20F, FOAM BLAST™ 30 silicone defoaming compounds and FOAM BLAST™550 polyacrylate defoamers available from Emerald; TEGO AIREX™ 920 polyacrylate defoamer and TEGO AIREX™ 980 from Degussa, SILMER ACR™ Di-10 and ACR™ Mo-8 polydimethylsiloxane acrylate copolymer from Siltech Corporation, FOAMEX N™ or TEGO AIREX™ 900 silicone based defoamers available from Degussa or BYK™ 1790 silicone-free defoamer from BYK Chemie. The defoamer/deaerator is pre-sent in the compositions in a sufficient amount to prevent formation of bubbles and/or foam. If too much is used, adhesion to the desired surfaces and adhesives may be negatively impacted. The defoamer and/or deaerator may be present in an amount of about 0.01 percent by weight or greater based on the weight of the composition, about 0.05 percent by weight or greater or about 0.1 percent by weight or greater. The defoamer/deaerator may be present in an amount of about 2.0 percent by weight or less or about 1.0 percent by weight or less based on the weight of the composition.

These compositions may contain an additive to improve scratch resistance. Any additive which improves scratch resistance may be utilized. Exemplary scratch resistance additives may include silicates, aluminas, zirconias, carbides, oxides, nitrides or any other fillers with high hardness. Exemplary scratch resistance additives may include alumina (e.g., alpha alumina), silica, zirconia, boron carbide, silicon carbide, cerium oxide, glass, diamond, aluminum nitride, silicon nitride, yttrium oxide, titanium diboride, aluminosilicates (i.e. “Zeeospheres” from 3M), titanium carbide, combinations thereof, and the like. Exemplary scratch resistance additives may be silicates and aluminas. Exemplary scratch resistance additives may include nanometer sized silica fillers. The scratch resistance additives may have a particle size of about 10 micrometers or less or about 5 micrometers or less. The scratch resistance additives may be present in a sufficient amount to enhance the surface hardness and abrasion resistance of a coating and in an amount such that a homogeneous dispersion can be prepared. The scratch resistance additives may be present in an amount of about 0.1 percent by weight or greater of the composition or about 0.5 percent by weight or greater. The scratch resistance additives may be present in an amount of about 5 percent by weight or less of the composition, about 2 percent by weight or less or about 1 percent by weight or less.

These compositions may comprise an additive to improve surface slip properties. Any known composition that improves surface slip properties may be used. Exemplary surface slip additives may be a polyester modified polydimethyl siloxanes, waxes and the like. Exemplary waxes include those based on polyethylene, polytetrafluoroethylene or polypropylene wax dispersions in acrylate monomers, such as the EVERGLIDE™ or 5-395 or SST series of products from Shamrock Technologies, or polyamide particles such as ORGASOL™ from Arkema, or montan wax with reactive acrylate groups, such as CERIDUST™ TP 5091 from Clariant, or CERAFLGUR™ wax powders from Byk-Chemie. The wax may be in powder form having a particle size which is smaller than the desired thickness of the coating prepared from the composition. The maximum particle size may be about 30 microns or less, about 25 microns or less, about 20 microns or less or about 15 microns or less. The wax may be highly crystalline. Exemplary waxes comprise a polyethylene, polypropylene, polyamide, polytetrafluoroethylene, or blends and/copolymers thereof. The wax may be crystalline polyethylene or polytetrafluoroethylene or blends of polyethylene with polytetrafluoroethylene. The surface slip additives may be present in an amount of about 0.1 percent by weight or greater of the composition or about 0.5 percent by weight or greater. The surface slip additives may be present in an amount of about 5 percent by weight or less of the composition, about 2 percent by weight or less or about 5 percent by weight or less.

The compositions disclosed herein can be used to prepare coatings. Such structures may be cured and/or crosslinked. The crosslinked compositions may be crosslinked through the nucleophilic groups pendant from the polymer chains by the compounds containing two or more 1,1-dicarbonyl 1-alkene groups.

Disclosed are articles comprising substrates containing pigmented base coats on the substrates with coatings disclosed herein. The base coats may have a basic character which is sufficient to cure and/or cross-link the compositions. The coatings may be clear and function as clear coats. The coatings disclosed may contain any additional components utilized in coating such as pigments, adhesion promoters, fire retardants, and ingredients as disclosed herein and the like. Coatings disclosed herein may contain pigments and function as stand-alone coatings of base coats with a clear coat disposed above such base coats.

The coatings may cure and/or crosslink when exposed to certain conditions. When the coatings are exposed to relatively strong bases and or elevated temperatures they cure and crosslink at the same time. If they are exposed to mildly basic materials at relatively low temperatures, less than about 50° C. or less than about 40° C. they may not completely cure or crosslink. Such coatings or films may be cured by exposure to elevated temperatures to cure as disclosed herein.

### ILLUSTRATIVE EMBODIMENTS OF THE INVENTION

The following examples are provided to illustrate the invention but are not intended to limit the scope thereof. All parts and percentages are by weight unless otherwise indicated.

The reaction procedure is described as follows: a three neck 100 mL round bottom flask with a distillation head, thermometer, vacuum adapter, and collection flask are assembled using high vacuum grade grease along with a heating mantle, thermocouple, and a magnetic stir bar. The reaction mixture is subjected to agitation typically ranging from 400-600 rpm. Vacuum is used to remove subsequent byproducts from the reaction mixture and the various pressures are indicated below along with the mix time in each case. In some cases, nitrogen gas is used to purge the mixture in lieu of vacuum and, if applicable, is indicated below. In each case, the mole equivalent is relative to the diethyl methylene malonate (“DEMM”) monomer used.

NMR spectroscopy is employed using a 300 MHz NMR to analyze reaction mixtures. Samples are prepared using chloroform-d (CDCl₃) and hexamethyldisiloxane as an internal standard appearing at about 0 ppm. For 1,1-disubstituted alkene compounds with symmetrical substituents (e.g., DEMM), the reactive alkene functionality (i.e., the double bond) appears at about 6.45 ppm. For 1,1-disubstituted alkene compounds with asymmetrical substituents, the reactive alkene functionality appears as a doublet at about 6.45 ppm. In most cases, four NMR scans are run on each samples specimen with a 20 second delay between scans.

GC-MS is employed to determine conversion of starting materials to the desired transesterified product(s) and detect the presence of any byproducts. A helium gas (carrier gas) purge of about 1 mL/min is employed to aid the ionized in sample reaching the MS detector. Typical sample injection volumes of 1-2 μL of about 2-5 percent of the reaction mixture in dichloromethane (CH₂Cl₂) are used for injecting into the GC-MS instrument. The GC-MS profile method involves maintaining the oven at 100° C., followed by a ramp of 15° C./min to 250° C. Typical run times range from 18-23 minutes. Retention times of 1,1-disubstituted alkene compounds, based on the above-mentioned method, range from 4.5-17 min and are strongly dependent on the substituents and the ease of ionization of the particular molecule in the GC chamber.

Gel permeation chromatography (GPO) is used to determine the molecular weight of the polyester macromers formed after transesterification. Polymethylmethacrylate standards (PMMA), covering a range of 500 to 1.08 million in number average molecular weight (Mn) are used to plot the calibration curve. Samples are dissolved in THE and filtered before injection. A 10 μL injection volume is utilized at 1 ml/min. Columns are maintained at 35° C. and 75 bar (750,000 pacals) pressure. A refractive index detector is utilized downstream and is also maintained at 75 (750,000 pacals) bar pressure. The amount of different species in the composition are calculated based on the percent area of the molecular weight peak on the chromatogram.

Ingredients and Products

Pentane Diol

| | |
|---|---|
| DEM | Diethyl malonate |
| DEMM | Diethyl methylene malonate |
| | (diethyl 1-methylene-1,1-dicarboxylate) |
| MeHQ | Mono methyl ether hydroquinone |
| MSA | Methanesulfonic acid |
| Catalyst | CALB Lipase Enzyme |

### Example 1—Preparation of Di-functional Monomer from Pentane Diol and DEMM

A round bottom flask is charged with DEMM (172 g, 1 mol), pentanediol (26 g, 0.25 mol) and CALB lipase enzyme (8.6 g) (purchased from CLEA) 5 weight percent based on DEMM. The round bottom flask is placed on a rotovap preheated to 45° C. and pressure of 150 mm Hg is applied. After 1 hour the reaction is checked for completion by GCMS and HNMR. Once the pentanediol has been consumed, the reaction has gone to completion. The product mixture is about a 65/35 mixture of difunctional monomer and DEMM according to GCMS analysis. The reaction mixture is filtered to remove enzyme. A 3 neck round bottom flask equipped with mechanical agitator, thermometer and a condenser is charged with the reaction mixture formed. The reaction mixture is distilled at 65° C. and a pressure <0.800 mm Hg for 2 hours or until the amount of difunctional monomer is greater than 65 percent by weight of the solution. The typical product composition is: 67 percent DEMM-pentanediol multifunctional monomer and 33 percent DEMM.

### Example 2—Endcapping Diethyl Malonate with Pentane Diol

A round bottom flask is charged with pentanediol (260 g 2.5 mol), DEM (159 g, 1 mol) and CALB lipase enzyme (18 g) (purchased from CLEA), 7 weight percent based on pentanediol. The round bottom flask is placed on a rotovap and preheated to 45° C. and a pressure of 150 mm Hg is applied. After 1 hour the reaction is checked for completion by GCMS and HNMR. Once the DEM has been consumed, the reaction has gone to completion. The reaction mixture is filtered to remove enzyme. A 3 neck round bottom flask equipped with mechanical agitator, thermometer and a condenser is charged with the reaction mixture which is distilled at 100° C. and less than 0.800 mmHg for 2 hours or until the amount of pentanediol is about 10 weight percent of the reaction mixture (as determined by GCMS). The typical product composition is about 90 percent by weight or pentanediol capped diethyl malonate and about 10 percent by weight pentanediol.

### Example 3—Preparation of Polyester Macromer

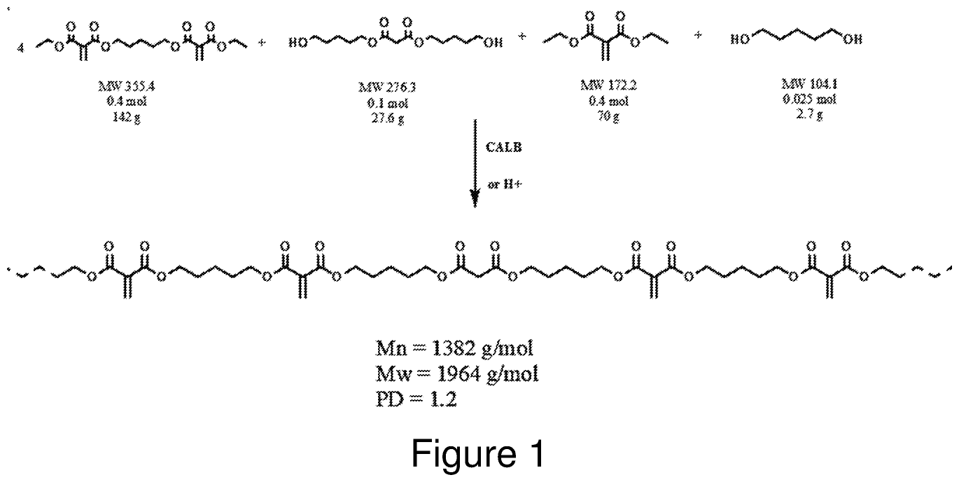

A round bottom flask is charged with DEMM-pentanediol difunctional monomer (142 g, 0.4 mol) and pentanediol capped diethyl malonate (27.6 g 0.1 mol), diethyl methylene malonate, (70 g, 0.4 mol), pentane diol (2.7 g, 0.025 mol) and CALB lipase enzyme (10 g) 7 weight percent based on DEMM-pentanediol difunctional monomer. The round bottom flask is placed on a rotovap preheated to 45° C. and at a pressure of 150 mm Hg. After 1 hour the reaction mixture is checked for completion (disappearance of pentanediol-difunctional monomer) by GCMS. The reaction mixture is filtered to remove the enzyme. The resulting solution is examined by GPC. The product composition is generally comprised of the following: 60-75 weight percent of polyester macromer, 20-30 weight percent of pentanediol-difunctional monomer, 0-10 weight percent of DEMM. 100 ppm MEHQ and 10 ppm MSA are added to the final product. MSA is accurately measured out from a 1 percent by weight MSA:DEMM solution. This reaction is illustrated by the equation shown in FIG. 1.

### Example 4—Preparation of Polyester Macromer

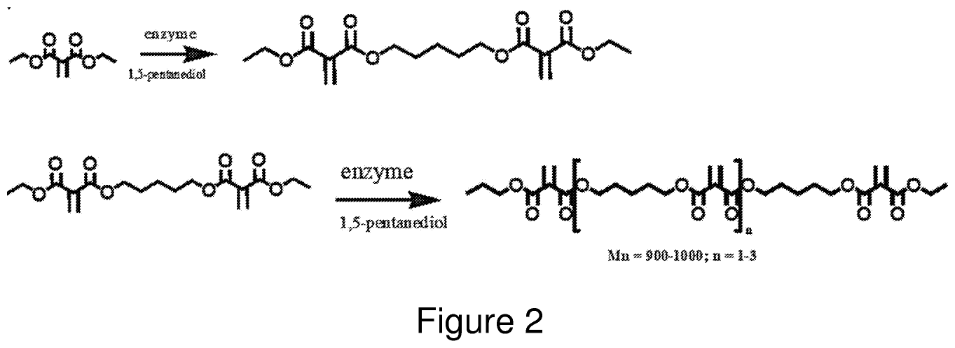

A round bottom flask is charged with DEMM-pentanediol difunctional monomer (142 g, 0.4 mol), diethyl methylene malonate, (70 g, 0.4 mol), pentane diol (10.8 g, 0.10 mol) and CALB lipase enzyme (10 g) 7 weight percent based on DEMM-pentanediol difunctional monomer. The round bottom flask is placed on a rotovap preheated to 45° C. at a pressure of 150 mm Hg. After 1 hour the reaction mixture is checked for completion (disappearance of pentanediol- difunctional monomer) by GCMS. The reaction mixture is filtered to remove the enzyme. The resulting solution is examined by GPC. The product composition is generally comprised of the following: 60-75 weight percent of polyester macromer, 20-30 weight percent of pentanediol-difunctional monomer, 0-10 weight percent of DEMM. 100 ppm MEHQ and 10 ppm MSA are added to the final product. MSA is accurately measured out from a 1 percent by weight MSA DEMM solution. This reaction is illustrated by the equation in FIG. 2.

For most of the experiments the composition is 60-70 percent by weight of polyester macromers having a molecular weight of 800, 30-35 percent by weight DEMM-pentane diol difunctional molecule and 5-10 percent by weight DEMM. References to polyester composition refers to this general composition. Any deviations from this will be specifically mentioned.

### Example 5: Functional Monomers Incorporated into Emulsion Polymers (Latex) to Make Functional Emulsion Polymers

A surfactant micellar solution is prepared by adding 2 ml of 10 weight percent of Triton™ X-405 surfactant into 13 ml of DI water and stirred for 10 minutes in a 3 neck round bottom flask (250 ml) equipped with a magnetic stir bar to allow the surfactant to dissolve and form the micelles. Then 1.5 g of butyl acrylate and 1.5 g of methyl methacrylate are added to the mixture. The mixture is stirred and heated to 80° C. under nitrogen purge. When the reaction mixture reaches 80° C., an initiator solution is fed at a rate of 0.05 ml per minute using a syringe pump for 40 minutes. The initiator consists of 2 weight percent of AIBI (2,2 azobis(2-(2-imidazolin-2-yl) propane dihydrochloride) initiator in water. Then a functional monomer mixture is fed into the reaction vessel at 0.12 ml per minute for 2 hours,

The functional monomer mixture is separately prepared as follows: 1 weight percent of Triton™ X-405 surfactant, 19 weight percent water and 80 weight percent of a monomer mixture (with a ratio of 6 g butyl acrylate, 6 g MMA, 1 g functional monomer) is stirred for 5 minutes until it becomes a white emulsion. After the feed step is complete the temperature is maintained at 85° C. for an additional 30 minutes to complete the reaction. The functional monomers included are methacrylic acid (MAA), dimethylaminoethyl methacrylate (DMAEMA), vinyl benzoic acid (VBA) and acrylamide propane sulfonic acid (AMPS). The initiator did not polymerize. The latex without functional monomer exhibits a particle size of 114.5 nm by dynamic light scattering (DLS) and a polydispersity index of 0.005 indicating a very narrow size distribution. The measured T₉ is 14.09° C.

### Example 6: Emulsion Polymers (Latexes) with Functional Monomers Crosslinked with Polyester Macromer

5 g of functional latex is added to 4 different 20 ml vials. The pH value of each latex is adjusted to 2, 4, 7 and 10 using 1M NaOH or 1M HCl aqueous solutions. Then, 5 weight percent a polyester macromer prepared from Butane diol and Diethyl methylene malonate, (BDPE) is added directly to each vial at room temperature, stirring with a magnetic stir bar for 10 minutes.

MEK Double Rub Testing

MEK double rub test and swelling ratio tests are conducted in triplicate using the following procedure. 5 ml of functional latex is modified to different pH values (2, 4, 7, 10), then 5 weight percent of BDPE is added and the dispersion is mixed under room temp for 10 minutes. 2 ml of the above solution is dispensed onto a stainless metal plate and coated using a draw down tool (100 μm thick coating) to draw the solution into a flat, thin layer (thickness of dried film is 30-40 μm). The coating is dried in air at room temperature for one hour. Using a 200 g-weight bottle with cheesecloth (100% cotton) attached to the bottom, and saturated with MEK the coatings are rubbed with the MEK saturated pad. The pad is changed after 20 double rubs. (One forward and back motion is a double rub.) The total number of rubs until almost all the coating disappears is counted. The results are compiled in Table 1.

TABLE 1

| | | With 5% BDPE | | | |
|---|---|---|---|---|---|
| Rub test | No BDPE | PH = 2 | PH = 4 | PH = 7 | PH = 10 |
| MAA latex | 30 (pH = 4) | 25 | 36 | 130 | >300 |
| DMAEMA latex | 4 (pH = 7) | 6 | 7 | 4 | 10 |
| VBA latex | 5 (pH = 4) | 11 | 30 | 16 | 10 |

The results show the effects of BDPE crosslinking. DMAEMA functional latex shows some improvement. Vinyl benzyl acid latex show significant improvement, with an apparent optimum at pH 4. The coating with MAA and no BDPE is very friable. Addition of BDPE converts it into a visibly tougher single-phase coating. The best morphology is demonstrated at pH 10.

### Example 7: Emulsion Polymers (Latexes) with Functional Monomers Crosslinked by Polyester Macromer (BDPE)

The procedure is described as follows. 2 g of functional latex (38 weight percent solid content) is added to 6 different 7 ml vials. The pH of each is adjusted to 7 using 1M NaOH or 1M HCL aqueous solutions.
2, 4, 6, 8, 10 and, 15 weight percent of BDPE are added directly to each vial at room temperature, stirring with a magnetic stir bar for 2 hours. 1 ml of the above solution is dispensed onto a metal plate (11 cm×5 cm) and coated using a draw down tool (100 μm thick coating) to draw the solution into a flat, thin layer. The coating is dried in air at room temperature overnight (15 hours). Using a 1 kg-weight with cheesecloth (100% cotton) attached to the bottom, and saturated with MEK. the coating is rubbed with the MEK saturated pad, which is changed pad after 20 double rubs. The total double rubs until almost all the coating disappears are counted. The functional monomers and results are compiled in Table 2.

TABLE 2
Rub test

| Functional | | | | | |
|---|---|---|---|---|---|
| Monomer | | PH = 2 | PH = 4 | PH = 7 | PH = 10 |
| AMPS | No BDPE | 48 | 51 | 47 | 45 |
| | 5% BDPE (0.5 h) | 49 | 50 | 85 | 84 |
| | 5% BDPE (24 h) | 51 | 52 | 190 | 79 |
| HEA | No BDPE | 18 | 15 | 11 | 8 |
| | 5% BDPE (0.5 h) | 20 | 22 | 13 | 9 |
| MAH | No BDPE | 7 | 7 | 9 | 32 |
| | 5% BDPE (0.5 h) | 8 | 8 | 13 | 80 |

AMPS and MAH show great increase with BDEP addition under certain PH, and the film formation becomes more smooth and flat with BDPE.

### Examples 8-10: Detailed Crosslinking Screens of Latexes Functionalized with MAA and AMPS Functional Monomers and Reacted with BDPE Crosslinker

The following examples use varied functional monomer and BDPE levels and crosslinking is evaluated via MEK double rubs.

### Example 8: Crosslinking Experiments with MAA Functional Latex and BDPE

According to the procedure of the previous example BDPE is mixed with lattices for predetermined “Pot Times” at room temperature. The crosslinked polymers formed are applied to substrates and allowed to cure for “Curing Time” stated below. The MEK rub test is performed with a 1 kg weight. Sodium hydroxide is used to modify the PH of the MAA latex described hereinbefore to 7.2 g of the MAA latex is mixed with the BDPE crosslinker in 7 ml vial, the mixture is stirred for the shown predetermined “Pot Time” at room temperature until BDPE droplets are not be visually observed, the coating is applied to a 10 cm long stainless metal film with a 100 μm drawdown tool, which is then cured for 15 hours. The “Pot” Time is the amount of time BDPE is mixed with latex before applying coating the coating. Table 3 shows the impact of reaction time and curing time on MEK rub testing results.

TABLE 3

| Reaction time | 1 h | 2 h | 3 h |
|---|---|---|---|
| Rub cycles | 12 | 12 | 11 |
| Curing time | 0.5 h | 7 h | 24 h |
| Rub cycles | 12 | 13 | 22 |

Results of varying MAA and BDPE levels at 2 hour pot time 15 hour drying time are shown in Table 4.

TABLE 4

| | BDPE | | | | | | |
|---|---|---|---|---|---|---|---|
| | 0% | 2% | 4% | 6% | 8% | 10% | 15% |
| 0% MAA | 4 | 4 | 4 | 4 | 14 | 4 | 5 |
| 1% MAA | 6 | 12 | 7 | 10 | 11 | 9 | 8 |
| | 6 | 10 | 9 | 10 | 9 | 11 | 8 |
| | 6 | 10 | 9 | 10 | 10 | 10 | 9 |
| 2% MAA | 9 | 8 | 10 | 12 | 8 | 10 | 20 |
| | 9 | 8 | 8 | 14 | 9 | 9 | 19 |
| | 8 | 7 | 9 | 11 | 9 | 10 | 20 |
| 3% MAA | 12 | 10 | 10 | 14 | 23 | 30 | 38 |
| | 11 | 14 | 11 | 11 | 25 | 31 | 34 |
| | 10 | 11 | 11 | 13 | 25 | 30 | 37 |
| 4% MAA | 17 | 15 | 21 | 23 | 22 | 46 | 62 |
| | 16 | 18 | 28 | 24 | 25 | 47 | 57 |
| | 16 | 16 | 23 | 23 | 26 | 45 | 60 |
| 5% MAA | 64 | 64 | 70 | 73 | 77 | 65 | 170 |
| | 65 | 68 | 71 | 83 | 87 | 71 | 192 |
| | 60 | 65 | 71 | 70 | 75 | 70 | 175 |

The pot time (stirring time) between MAA latex with BDPE between 1-3 hours does not have influence on the rub test. But the curing time greatly increased the completion of the crosslinking reaction. The pot time (stirring time) between MAA latex with BDPE between 1-3 hours does not have influence on the rub test. The curing time greatly increased the completion of the crosslinking reaction. There is no effect of pot time on coating properties. Enhanced properties indicating crosslinking are observed at 1% and greater functional monomer levels. Enhanced properties indicating crosslinking are observed at 2% and greater BDPE levels. Enhanced properties and crosslinking are observed at room temperature and higher. Pot lives of at least 40 hours is observed

### Example 9 Crosslinking Experiments with AMPS Functional Latex and BDPE

Sodium hydroxide is used to modify the PH of AMPS latex, described hereinbefore, to 7. 2 g AMPS latex is mixed with BDPE crosslinker in 7 ml vial. The mixture is stirred for 1 h under room temperature (until the BDPE droplets are not visually observed). The mixture is maintained in the pot for the predetermined “Pot Time”. The coating is applied to a 110 cm long stainless metal film with 100 μm drawdown tool. The film is tested according to the MEK double rub test (with 1 kg weight) right after drying. The effect of AMPS “pot time” shows a strong effect on final coating properties, is shown in Table 5.

TABLE 5

| | | 5% BDPE | | | |
|---|---|---|---|---|---|
| 3% AMPS latex | No BDPE | 0.5 h | 4 h | 24 h | 40 h |
| PH = 7 | 46 | 59 | 70 | 130 | 127 |

The concentration of AMPS in the latex is varied. The latex and BDPE are mixed for 1 hour and allowed to stay in the pot overnight. After 15 hours “pot time”, the latex is applied to a substrate as described hereinbefore and as soon as the coating has dried the MEK rub test is performed. The results are compiled in Table 6.

TABLE 6

| | BDPE | | | | | | |
|---|---|---|---|---|---|---|---|
| | 0% | 2% | 4% | 6% | 8% | 10% | 15% |
| 0% AMPS | 4 | 4 | 4 | 4 | 4 | 4 | 5 |
| 1% AMPS | 6 | 6 | 8 | 9 | 10 | 11 | 16 |
| 2% AMPS | 17 | 11 | 9 | 11 | 11 | 20 | 32 |
| 3% AMPS | 20 | 36 | 56 | 56 | 61 | 67 | 59 |
| 4% AMPS | 150 | 180 | 183 | 240 | 212 | 217 | 230 |

### Example 10: Crosslinking Experiments with AMPS Functional Latex and BDPE Via Swelling

A crosslinked latex containing AMPS is prepared as described in Example 7. The swelling ratio procedure is determined by weighing the glass vial (w1), adding solid samples into the vial, write down the weight of dry samples (w2). Add DMSO or chloroform into the vial until it immerses the solid. Allow swelling for 24 hours at room temperature, then withdraw the solvent and weigh glass vial with gel (w3).

$$Calculate the swelling ratio = 1 - \frac{w 2 - w 1}{w 3 - w 1} .$$

The results are compiled in Table 7.

TABLE 7

| | BDPE | | | | | | |
|---|---|---|---|---|---|---|---|
| | 0 | 2 | 4 | 6 | 8 | 10 | 15 |
| | wt % | wt % | wt % | wt % | wt % | wt % | wt % |
| AMPS | NA | 54.60% | 55.56% | 71.00% | 56.45% | 65.70% | 57.82% |
| 1 wt % | | | | | | | |
| AMPS | NA | 60.21% | 60.06% | 59.97% | 58.49% | 60.96% | 63.01% |
| 2 wt % | | | | | | | |
| AMPS | NA | 66.57% | 61.94% | 60.81% | 61.33% | 61.99% | 60.00% |
| 3 wt % | | | | | | | |
| AMPS | NA | 61.21% | 60.49% | 58.97% | 61.76% | 67.94% | 63.70% |
| 4 wt % | | | | | | | |

NA: coating dissolved - no crosslinking

### Example 11: Neutralized Functional Monomers Crosslinked by BDPE

The functional monomers are neutralized in DI water by 1M NaOH solution to a pH value of 7, followed by nitrogen blow drying. The reaction of BDPE directly with neutralized functional monomers (weight ratio 1:10) is evaluated with rheometer and by visual observation. Where the functional monomer is MAA salt the reaction mixture gels in 10 min and the process is exothermic. Where the functional monomer is an AMPS salt, the mixture does not gel in 24 hours. The comparison of water, water/TritonX405 (2 weight percent), water/TritonX405(2 weight percent)/methacrylate acid salt (10 weight percent) initiation of BDPE macromer is conducted under room temperature. BDPE is added into a petri dish and mixed separately with the above three liquid mixtures (2 weight percent according to BDPE weight), well-mixed and reacted for 24 hours. The results are compared by visual observation. The results are summarized below: Water initiated BDPE showed no reaction in 24 hours. Water/TritonX405(2 wt %) initiated BDPE showed no reaction in 24 hours. Water/TritonX405 (2 wt %); methacrylate acid salt (10 weight percent) initiated BDPE polymerized in 12 hours, the mixture turned from transparent mixture (liquid mixture) to white polymer mixture (hard solid) with water evaporation.

### Example 12: Crosslinking of AMPS and MAA Functional Latex with BDPE Crosslinker at Various Ratios, Curing Times and Mixing Procedures

An AMPS latex, as described earlier, is directly mixed with BDPE. Sodium hydroxide is used to modify the PH of 4 weight percent of AMPS latex to 7 (Tg: 17.65° C.). Directly mixing 7 g of the AMPS latex with 2, 8 and 15 weight percent AMPS with the BDPE crosslinker in 20 ml vial. The mixture is stirred for 2 hours under room temperature, until BDPE droplets are not be visually observed. The mixture is applied to a 110 cm long stainless metal film with 100 μm thickness drawdown tool, and cured for 20 hours, 40 hours or 70 hours before the MEK double rub test, with 1 kg weight. The results are compiled in Table 8.

TABLE 8

| Time | | | 20 h | 40 h | 70 h |
|---|---|---|---|---|---|
| 1% AMPS | 2% BDPE | Average | 9 | 12 | 11 |
| | | STDEV | 0.7 | 3.5 | 1.4 |
| | 8% BDPE | Average | 13 | 16 | 28 |
| | | STDEV | 1.4 | 2.1 | 2.8 |
| | 15% BDPE | Average | 58 | 91 | 117 |
| | | STDEV | 1.4 | 4.9 | 7.1 |
| 3% AMPS | 2% BDPE | Average | 24 | 48 | 80 |
| | | STDEV | 4.9 | 4.2 | 10.6 |
| | 8% BDPE | Average | 60 | 68 | 106 |
| | | STDEV | 9.9 | 10.6 | 8.5 |
| | 15% BDPE | Average | 92 | 130 | 145 |
| | | STDEV | 2.1 | 5.7 | 20.5 |
| 4% AMPS | 2% BDPE | Average | 182 | 248 | 368 |
| | | STDEV | 0.7 | 4.9 | 8.5 |
| | 8% BDPE | Average | 352 | 397 | 526 |
| | | STDEV | 2.8 | 9.2 | 6.4 |
| | 15% BDPE | Average | 413 | 435 | 707 |
| | | STDEV | 9.9 | 26.2 | 12.7 |

*STDEV: standard deviation

The result indicates that the rub performance of latex coating is improved with higher level of BDPE crosslinker and longer curing time. The glass transition temperature is measured with Differential scanning calorimetry for 4 weight percent AMPS latex crosslinked with 0 percent, 2 percent, 8 percent, 15 percent BDPE. The results are shown below.

| BDPE level | 0 wt % | 2 wt % | 8 wt % | 15 wt % |
|---|---|---|---|---|
| Tg/° C. | 17.65 | 16.14 | 12.37 | 5.23 |

MAA Latex Directly Mixing with BDPE

Sodium hydroxide is used to modify the PH of 5 weight percent of MAA latex to 7 (Tg: 12.44° C.). 7 g of the MAA latex is directly mixed with 2, 8 and 15 weight percent of BDPE crosslinker in a 20 ml vial. The mixture is stirred for 2 hours under room temperature until BDPE droplets are not be visually observed. A coating of the mixture is applied to a 110 cm long stainless metal film with 100 μm thickness drawdown tool, and cured for 20 hours, 40 hours or 70 hours. The cured coatings are tested with the MEK rub double rub test with a 1 kg weight. The results are compiled in Table 8.

TABLE 8

| Time | | | 20 h | 40 h | 70 h |
|---|---|---|---|---|---|
| 1% MAA | 2% BDPE | Average | 10 | 8 | 8 |
| | | STDEV | 1.4 | 0.7 | 0.0 |
| | 8% BDPE | Average | 16 | 16 | 16 |
| | | STDEV | 0.7 | 0.0 | 3.5 |
| | 15% BDPE | Average | 25 | 29 | 34 |
| | | STDEV | 0.0 | 2.8 | 7.1 |
| 3% MAA | 2% BDPE | Average | 17 | 23 | 15 |
| | | STDEV | 2.1 | 4.2 | 2.8 |
| | 8% BDPE | Average | 46 | 70 | 65 |
| | | STDEV | 11.3 | 2.8 | 10.6 |
| | 15% BDPE | Average | 29 | 28 | 30 |
| | | STDEV | 2.1 | 5.7 | 1.4 |
| 5% MAA | 2% BDPE | Average | 34 | 34 | 46 |
| | | STDEV | 1.4 | 4.2 | 3.5 |
| | 8% BDPE | Average | 41 | 49 | 76 |
| | | STDEV | 0.7 | 2.1 | 11.3 |
| | 15% BDPE | Average | 61 | 80 | 137 |
| | | STDEV | 6.4 | 0.0 | 0.7 |

The performance of 5 weight percent MAA latex is significantly influenced by the amount of crosslinker and curing time. For 1 percent and 3 percent MAA latex, there is relatively less improvement. The glass transition temperature was measure with Differential scanning calorimetry for 5 weight percent MAA latex crosslinking with 0 percent, 2 percent, 8 percent and 15 percent BDPE (by weight).

| BDPE level | 0 wt % | 2 wt % | 8 wt % | 15 wt % |
|---|---|---|---|---|
| Tg/° C. | 12.44 | 12.35 | 11.08 | 9.84 |

MAA Latex Mixing with Pre-Emulsified BDPE

Sodium hydroxide is used to modify the PH of 5 weight percent of MAA latex to 7 (Tg: 12.44° C.). A pre-emulsified BDPE is prepared by mixing 2 weight percent of Triton X405 solution in DI water with 2, 8, and 15 weight percent of BDPE crosslinker (relative to solid content in latex) in 20 ml vial for 0.5 h. 7 g MAA latex is added. The mixture is stirred with a magnetic stir bar for 2 hours under room temperature. A coating of the mixture is applied to a 110 cm long stainless metal film with 100 mm thickness drawdown tool. The applied coat in is cured for 20 hours, 40 hours or 70 hours. The cured coating is tested according to the MEK rub double test result (with 1 kg weight). The results are compiled in Table 9.

TABLE 9

| Time | | | 20 h | 40 h | 70 h |
|---|---|---|---|---|---|
| 1% MAA | 2% BDPE | Average | 7 | 6 | 7 |
| | | STDEV | 0.7 | 0.0 | 0.7 |
| | 8% BDPE | Average | 11 | 12 | 12 |
| | | STDEV | 0.7 | 0.7 | 0.7 |
| | 15% BDPE | Average | 17 | 24 | 21 |
| | | STDEV | 0.7 | 2.1 | 0.7 |
| 3% MAA | 2% BDPE | Average | 12 | 13 | 15 |
| | | STDEV | 0.7 | 0.7 | 1.4 |
| | 8% BDPE | Average | 20 | 22 | 27 |
| | | STDEV | 2.1 | 0.0 | 2.8 |
| | 15% BDPE | Average | 13 | 14 | 15 |
| | | STDEV | 0.0 | 0.0 | 0.0 |
| 5% MAA | 2% BDPE | Average | 20 | 23 | 27 |
| | | STDEV | 1.4 | 1.4 | 0.0 |
| | 8% BDPE | Average | 31 | 35 | 51 |
| | | STDEV | 0.7 | 3.5 | 1.4 |
| | 15% BDPE | Average | 30 | 30 | 32 |
| | | STDEV | 4.2 | 0.0 | 0.7 |

Higher crosslinker contents caused ‘swelling effect’ where the film expanded and became easy to rub off the metal steel. A hypothesis is that the surfactant molecule protects the BDPE inside micelle which limits the contact with carboxyl group in aqueous phase.

Applying BDPE with Solvent onto Dried MAA Latex

Sodium hydroxide is used to modify the PH of 5 weight percent of MAA latex to 7 (Tg: 12.44° C.). Apply the coating to a 110 cm long stainless metal film with 100 μm thickness drawdown tool, let it cure for 1 hour until fully dried. BDPE is prepared by dissolving 2, 8, and 15 weight percent of BDPE crosslinker (relative to solid content in latex) in 2 g chloroform. The solvent mixture is applied onto the dried film and allowed to evaporate for 20 hours before subjecting the coating to the MEK rub double test result (with 1 kg weight). The results are compiled in Table 10.

TABLE 10

| Time | | | 20 h |
|---|---|---|---|
| 1% MAA | 2% BDPE | Average | 10 |
| | | STDEV | 2.1 |
| | 8% BDPE | Average | 36 |
| | | STDEV | 0.7 |
| | 15% BDPE | Average | 135 |
| | | STDEV | 7.1 |
| 3% MAA | 2% BDPE | Average | 32 |
| | | STDEV | 0.0 |
| | 8% BDPE | Average | 144 |
| | | STDEV | 2.8 |
| | 15% BDPE | Average | 231 |
| | | STDEV | 15.6 |
| 5% MAA | 2% BDPE | Average | 81 |
| | | STDEV | 2.1 |
| | 8% BDPE | Average | 267 |
| | | STDEV | 33.2 |
| | 15% BDPE | Average | >500 |
| | | STDEV | — |

Smooth and homogeneous surface morphology is obtained by applying the BDPE solvent mixture onto dried latex film. This method shows greatest improvement on rub-resistant performance where BDPE can fully contact the carboxy group on coating surface and gradual penetration through the film is allowed.

### Example 13: Study of Film Formation Process and Surface Properties

### Film Formation Process

Apply coatings of 5 weight percent MAA mixed with 0, 2, 4, 6, 8, 10 and 15 weight percent of BDPE on stainless metal plate with a 100 μm thickness drawdown tool. The coating is dried for an hour. The coatings film formation is visually observed. The results indicate that the coatings with higher ratio of MAA gives a relatively poor and flaky film, where the coating fragment separated from the substrate. However, such phenomenon is significantly improved with the addition of BDPE crosslinker.

Content Angle Experiment

The contact angle is measured with by the goniometer-microscope method. The equipment consists of a video camera with a suitable magnifying lens, a horizontal stage to mount samples, and computer with image-analysis software to precisely measure the angle of liquid-solid interface. The measurement is performed by dropping DI water with micro repeater onto the dried latex film, collected photos of droplets and analyzing the drop shape. Each test is repeated for more than 15 times. The results are compiled in Table 11

TABLE 11

| | Base | 5 wt % | 5 wt % MAA |
|---|---|---|---|
| | latex | MAA latex | latex + 15% BDPE |
| Contact angle | 66.3 | 58.78 | 68.91 |
| STDEV | 4.18 | 3.32 | 4.57 |

base latex is comprised of BA and MMA with a weight ratio of 6:4 There is a 10.13° increase of contact angle with the addition of BDPE crosslinker, which indicates higher surface tension and the hydrophobicity property of BDPE.

The AMPS latex is tested by preparing a film of 4 weight percent AMPS latex and 4 weight percent AMPS latex crosslinked with 15 weight percent of BDPE. Drop 2 ml of apple juice (pH around 4) is dropped on the top of the film, and which is left on the surface for 3 h. The control AMPS latex coating detaches from the surface. The coating of AMPS latex with 15% BDPE is not impacted by the acid.

The degree of crosslinking for MAA latex and AMPS latex via gel content experiment is studied by preparing a crosslinked latex as described above. The crosslinked coating is dried in 60° C. oven for 12 h to prepare solid samples. Weigh a glass vial (w1), add solid samples of the coating to the vial. Write down the weight of dried samples (w2). Add dimethylformamide to the vial until it covers the solid and let the solid dissolve for 10 h. Then withdraw the solvent from the vial and add dimethylformamide again to completely extract the non-crosslinked component inside the gel. Repeat this step for 3 times. Withdraw the liquid mixture in the vial, put the vial together with the swelled gel inside on hot plate (200° C.) for 10 h until the solid completely dries. Weigh the vial (w3).

$$Calculate the gel content = \frac{w 3 - w 1}{w 2} * 100 \% .$$

The results are compiled in Table 12.

TABLE 12

| BDPE level | | 0 wt % | 8 wt % | 15 wt % |
|---|---|---|---|---|
| MAA latex | Average | 0% | 52.82% | 76.25% |
| | STDEV | 0 | 0.0084 | 0.0145 |
| AMPS latex | Average | 0% | 48.46% | 48.37% |
| | STDEV | 0 | 0.0052 | 0.00815 |

### EXEMPLARY EMBODIMENTS

Embodiment 1. A composition comprising polymers having polymer chains prepared from monomers having unsaturated groups and functional groups which are nucleophilic and mixtures of monomers having unsaturated groups and monomers having unsaturated groups and functional groups which are nucleophilic, wherein the polymer chains are crosslinked by compounds containing two or more 1,1-dicarbonyl 1-alkene groups.

Embodiment 2. A composition according to Embodiment 1 wherein the polymer chains are crosslinked by the alkene groups of the compounds containing two or more 1,1-dicarbonyl alkene groups reacting with the nucleophilic groups of the polymer chains.

Embodiment 3. A composition according to Embodiment 1 or 2 wherein the nucleophilic groups comprise one or more of hydroxyl, carboxylic acids, amines, benzoic acids, sulfonates, and sulfates.

Embodiment 4. A composition according to any one of the preceding embodiments wherein the polymers contain about 1 percent by weight or greater of monomers containing nucleophilic functional groups based on the weight of the copolymer.

Embodiment 5. A composition according to any of the preceding embodiments wherein the polymers contain from about 1 percent by weight to about 20 percent by weight of the monomers containing nucleophilic functional groups.

Embodiment 6. A composition according to any of the previous embodiments wherein the compounds containing two or more 1,1-dicarbonyl alkene groups are present in an amount of about 0.1 percent by weight of the composition or greater.

Embodiment 7. A composition according to any of the previous embodiments wherein the compounds containing two or more 1,1-dicarbonyl alkene groups are present in an amount of from about 2 percent weight to about 15 percent by weight of the composition.

Embodiment 8. A composition according to the previous embodiments wherein the monomers having unsaturated groups comprise compounds that contain unsaturation in their backbone wherein the unsaturation is capable of polymerization via free radical or anionic polymerization.

Embodiment 9. A composition according to the previous embodiments wherein the polymers are prepared by cationic polymerization, condensation polymerization, addition polymerization of diisocyanates with carboxylated diols to make carboxylated polyurethanes, mechanical dispersions of any of the disclosed polymers, and dispersions of post-functionalized polymers.

Embodiment 10. A composition according to the previous embodiments wherein the monomers having unsaturated groups comprise one or more of 1,1-dicarbonyl-1-alkenes acrylates, methacrylates, acrylamides, methacrylamides, mono-vinylidene aromatic compounds, olefins, isocyanates, and conjugated dienes.

Embodiment 11. A composition according to the previous embodiments wherein the monomers having unsaturated groups comprise one or more of acrylates, methacrylates, acrylamides, and methacrylamides.

Embodiment 12. A composition according to the previous embodiments wherein the monomers having unsaturated groups comprise one or more of acrylates and methacrylates.

Embodiment 13. A composition according to the previous embodiments wherein the monomers having unsaturated groups and functional groups which are nucleophilic comprise on or more of methacrylic acid, acrylic acid, ethylene acrylic acid, maleic anhydride, 2-Acrylamido-2-methylpropanesulfonic acid, and acetoacetoxyethyl methacrylate.

14. A composition according to the previous embodiments wherein the compounds containing two or more 1,1-dicarbonyl alkene groups comprise one or more compounds prepared from one or more 1,1-dicarbonyl-1-alkenes and one or more polyols or from one or more 1,1-dicarbonyl-1-alkenes, one or more polyols and one or more diesters.

Embodiment 15. A composition according to the previous embodiments wherein the compounds containing two or more 1,1-dicarbonyl alkene groups comprise one or more polyester macromers containing one or more chains of the residue of one or more dials and one or more diesters wherein the residue of the one or more dials and the one or more diesters alternate along the chain and a portion of the diesters are 1,1-diester-1-alkenes and at least one terminal end comprises the residue of one of the 1,1-diester-1 alkenes and wherein one or more terminal ends may comprise the residue of one or more diols.

Embodiment 16. A composition according to the previous embodiments wherein the one or more chains of the residue of one or more diols and one or more diesters contain from 2 to 20 repeating units comprising the residue of at least one diester and one diol.

Embodiment 17. A composition according to the previous embodiments wherein the compounds containing two or more 1,1-dicarbonyl alkene groups comprise one or more polyester macromers prepared from butane diol and diethyl methylene malonate.

Embodiment 18. A composition according to the previous embodiments wherein the compounds containing two or more 1,1-dicarbonyl alkene groups comprise one or more compounds prepared from one or more 1,1-dicarbonyl-1-alkenes and one or more polyols.

Embodiment 19. A composition according to the previous embodiments wherein the compounds containing two or more 1,1-dicarbonyl alkene groups comprise one or more compounds prepared from two 1,1-dicarbonyl-1-alkenes and one diol to form a compound wherein the diol is end-capped with the two 1,1-dicarbonyl-1-alkenes.

Embodiment 20. A composition according to the previous embodiments comprising polymers having polymer chains prepared from monomers having unsaturated groups and functional groups which are nucleophilic, wherein the polymer chains are crosslinked by compounds containing two or more 1,1-dicarbonyl alkene groups dispersed in an aqueous dispersion containing one or more surfactants.

Embodiment 21. A composition according to Embodiment 20 wherein the surfactant is one or more of zwitterionic surfactants, anionic surfactants, non-ionic surfactants or cationic surfactants.

Embodiment 22. A composition according to Embodiment 20 wherein the surfactant is one or more of anionic surfactants or non-ionic surfactants.

Embodiment 23. A composition according to Embodiment 20 wherein the surfactant is one or more of non-ionic surfactants.

Embodiment 24. A composition according to Embodiment 20 to 23 which is cured and in the form of a coating.

Embodiment 25. A composition according to Embodiment 24 wherein the composition is a coating having a thickness of about 2 to about 160 microns.

Embodiment 26. A method comprising polymerizing in an aqueous emulsion monomers having unsaturated groups and monomers having unsaturated groups and functional groups which are nucleophilic to form polymers with one or more polymer chains wherein the nucleophilic groups are pendant from the polymer chains formed and contacting the polymers formed with compounds containing two or more 1,1-dicarbonyl alkene groups such that the compounds containing two or more 1,1-dicarbonyl alkene groups react with the nucleophilic groups to crosslink the polymer chains.

Embodiment 27. A method according Embodiment 26 wherein the surfactants are present in a sufficient amount to form a stable emulsion.

Embodiment 28. A method according to Embodiment 26 or 27 wherein the temperature at which the one or more polymer chains wherein the nucleophilic groups are pendant from the polymer chains are contacted with the compounds containing two or more 1,1-dicarbonyl alkene groups is about 0° C. to about 100° C.

Embodiment 29. A method according to Embodiment 26 comprising contacting water and a surfactant to form a micellular dispersion and adding to the micellar dispersion one or more polymerization initiators and monomers having unsaturated groups and monomers having unsaturated groups and functional groups which are nucleophilic to form polymers with polymer chains.

Embodiment 30. A method according to Embodiment 26 to 29 wherein the pH of the emulsion is about 4 or greater.

Embodiment 31. A method according to Embodiment 26 to 29 wherein the pH of the emulsion is about 7 or greater.

Embodiment 32. A method according to Embodiment 26 to 29 wherein the pH of the emulsion is about 4 to about 10.

Embodiment 33. A method according to Embodiment 26 to 29 wherein the pH of the emulsion is about 7 to about 10.

Embodiment 34. A method according to Embodiment 26 to 33 wherein the surfactant is one or more of anionic surfactants, non-ionic surfactants or cationic surfactants.

Embodiment 35. A method according to Embodiment 26 to 29 wherein the surfactant is one or more of anionic surfactants or non-ionic surfactants.

Embodiment 36. A method according to Embodiment 26 to 29 wherein the surfactant is one or more of non-ionic surfactants.

Embodiment 37. A method of forming a coating on a substrate comprising applying to the surface of the substrate a composition according to Embodiments 20 to 23 and allowing the water to volatilize away and the crosslinked polymer to from a coherent coating.

Embodiment 38. A method according to embodiment 37 wherein the composition is contacted with a substrate at ambient, lower than ambient or elevated temperatures.

Embodiment 39. A method according to embodiment 38 wherein the composition is contacted with a substrate at a temperature of about of about −40° C. to about 150° C.

Embodiment 40. A method according to embodiment 38 wherein the composition is contacted with a substrate at a temperature of about of about −40° C. to about 50° C.

Embodiment 41. A method comprising contacting a stabilized emulsion of polymers having polymer chains prepared from monomers having unsaturated groups and monomers having unsaturated groups and functional groups which are nucleophilic with compounds containing two or more 1,1-dicarbonyl alkene groups under conditions such that the polymer chains are crosslinked by compounds containing two or more 1,1-dicarbonyl alkene groups.

1. A composition comprising polymers having polymer chains prepared from monomers having unsaturated groups and functional groups which are nucleophilic and mixtures of monomers having unsaturated groups and monomers having unsaturated groups and functional groups which are nucleophilic, wherein the polymers contain from about 1 percent by weight to about 20 percent by weight of the monomers containing nucleophilic functional groups; wherein the polymer chains are crosslinked by compounds containing two or more 1,1-dicarbonyl 1-alkene groups wherein the compounds containing two or more 1,1-dicarbonyl alkene groups are present in an amount of from about 2 percent weight to about 15 percent by weight of the composition.

2. The composition according to claim 1, wherein the polymer chains are crosslinked by the alkene groups of the compounds containing two or more 1,1-dicarbonyl alkene groups reacting with the nucleophilic groups of the polymer chains.

3. The composition according to claim 1, wherein the nucleophilic groups comprise one or more of hydroxyl, carboxylic acids, amines, benzoic acids, sulfonates, and sulfates.

4-7. (canceled)

8. The composition according to claim 1, wherein the monomers having unsaturated groups comprise compounds that contain unsaturation in their backbone wherein the unsaturation is capable of polymerization via free radical or anionic polymerization.

9. (canceled)

10. The composition according to claim 1, wherein the monomers having unsaturated groups comprise one or more of 1,1-dicarbonyl-1-alkenes acrylates, methacrylates, acrylamides, methacrylamides, mono-vinylidene aromatic compounds, olefins, isocyanates, and conjugated dienes.

11. (canceled)

12. The composition according to claim 1, wherein the monomers having unsaturated groups comprise one or more of acrylates and methacrylates.

13. (canceled)

14. The composition according to claim 1, wherein the compounds containing two or more 1,1-dicarbonyl alkene groups comprise one or more compounds prepared from one or more 1,1-dicarbonyl-1-alkenes and one or more polyols or from one or more 1,1-dicarbonyl-1-alkenes, one or more polyols and one or more diesters.

15-19. (canceled)

20. The composition according to claim 1, comprising polymers having polymer chains prepared from monomers having unsaturated groups and functional groups which are nucleophilic, wherein the polymer chains are crosslinked by compounds containing two or more 1,1-dicarbonyl alkene groups dispersed in an aqueous dispersion containing one or more surfactants.

21. (canceled)

22. The composition according to claim 20 wherein the surfactant is one or more of anionic surfactants or non-ionic surfactants.

23. The composition according to claim 20 wherein the surfactant is one or more of non-ionic surfactants.

24. The composition according to claim 20, which is cured and in the form of a coating.

25. (canceled)

26. A method comprising contacting water and a surfactant to form a micellular dispersion and adding to the micellar dispersion one or more polymerization initiators and monomers having unsaturated groups and monomers having unsaturated groups and functional groups which are nucleophilic to form polymers with polymer chains wherein the nucleophilic groups are pendant from the polymer chains formed and contacting the polymers formed with compounds containing two or more 1,1-dicarbonyl alkene groups such that the compounds containing two or more 1,1-dicarbonyl alkene groups react with the nucleophilic groups to crosslink the polymer chains.

27. (canceled)

28. The method according to claim 26, wherein the temperature at which the one or more polymer chains wherein the nucleophilic groups are pendant from the polymer chains are contacted with the compounds containing two or more 1,1-dicarbonyl alkene groups is about 0° C. to about 100° C.

29-32. (canceled)

33. The method according to claim 26, wherein the pH of the emulsion is about 7 to about 10.

34. (canceled)

35. The method according to claim 26, wherein the surfactant is one or more of anionic surfactants or non-ionic surfactants.

36. The method according to claim 26, wherein the surfactant is one or more of non-ionic surfactants.

37. The method of forming a coating on a substrate comprising applying to the surface of the substrate a composition according to claim 20, and allowing the water to volatilize away and the crosslinked polymer to from a coherent coating.

38. (canceled)

39. The method according to claim 37, wherein the composition is contacted with a substrate at a temperature of about of about −40° C. to about 150° C.

40. (canceled)

41. A method comprising contacting a stabilized emulsion of polymers having polymer chains prepared from monomers having unsaturated groups and monomers having unsaturated groups and functional groups which are nucleophilic with compounds containing two or more 1,1-dicarbonyl alkene groups wherein the polymer chains are crosslinked by compounds containing two or more 1,1-dicarbonyl alkene groups.
